(19) United States
(12) Patent Application Publication
(10) Pub. No.: US 2002/0035537 A1
(43) Pub. Date: Mar. 21, 2002

(54) Method for economic bidding between retailers and suppliers of goods in branded, replenished categories

(76) Inventors: Matthew A. Waller, Fayetteville, AR (US); Earl F. Dulaney, Fayetteville, AR (US)

Correspondence Address: HEAD, JOHNSON & KACHIGIAN, 112 WEST CENTER STREET, SUITE 230, FAYETTEVILLE, AR, 72701, US

(21) Appl. No.: 09/967,586

(22) Filed: Sep. 28, 2001

Related U.S. Application Data
(63) Continuation-in-part of application No. 09/860,416, filed on May 18, 2001.
Application No. 09/860,416 is a continuation-in-part of application No. 09/735,041, filed on Dec. 11, 2000.
Application No. 09/735,041 is a continuation-in-part of application No. 09/644,596, filed on Aug. 23, 2000.
Application No. 09/644,596 is a continuation-in-part of application No. 09/475,612, filed on Dec. 30, 1999.
(60) Provisional application No. 60/117,749, filed on Jan. 26, 1999.

(51) Int. Cl. G06F 17/60

(52) U.S. Cl. 705/37

(57) ABSTRACT

The present invention is a method for an economic bidding process which enables retailers to generate competition for merchandising space or inventory investment between suppliers of items in branded, replenished categories. This process enables a retailer's acquisition, evaluation, and comparison of economic bids from multiple suppliers through the merchandise optimization and collaboration technology also disclosed. In the economic bidding process the use of the same set of data, financial metrics, and economic model by all parties facilitates comparison of bids based on a wide variety of variables, as opposed to comparison based on cost alone as in traditional bidding. Suppliers can propose bids, and retailers evaluate them, based on an economic picture that is larger than cost alone. Hence, the bidding process enabled by the present invention is termed an “economic” bidding process.

### REFERENCE TO PENDING APPLICATIONS

This application is a continuation-in-part of U.S. patent application Ser. No. 09/860,416 entitled A SYSTEM, METHOD AND ARTICLE OF MANUFACTURE TO OPTIMIZE INVENTORY AND INVENTORY INVESTMENT UTILIZATION IN A COLLABORATIVE CONTEXT filed on May 18, 2001, which is a continuation-in-part of prior U.S. patent application Ser. No. 09/735,041 entitled SYSTEM, METHOD AND ARTICLE OF MANUFACTURE TO DETERMINE AND COMMUNICATE REDISTRIBUTED PRODUCT DEMAND filed on Dec. 11, 2000, which is a continuation-in-part of prior U.S. patent application Ser. No. 09/644,596 entitled SYSTEM, METHOD AND ARTICLE OF MANUFACTURE TO OPTIMIZE INVENTORY AND MERCHANDISING SPACE UTILIZATION IN A COLLABORATIVE TEXT filed on Aug. 23, 2000, which is a continuation-in-part of prior U.S. patent application Ser. No. 09/475,612 entitled SYSTEM, METHOD AND ARTICLE OF MANUFACTURE TO OPTIMIZE INVENTORY AND MERCHANDISING SHELF SPACE UTILIZATION filed on Dec. 30, 1999, which is a continuation-in-part of prior U.S. Provisional Application Serial No. 60/117,749 entitled STORE LEVEL OPTIMIZATION SYSTEM filed on Jan. 26, 1999.

### BACKGROUND

1. Field of the Invention

The present invention relates generally to inventory management systems and processes at the retail, wholesale and/or distributor level. In particular, the present invention involves a system, method and article of manufacture that optimizes inventory and merchandising space utilization based upon cost, lost sales, profit, and sales volume with or without considering physical space constraints. In addition, the present invention allows for this optimization in a collaborative environment. Furthermore, the present invention involves a system, method and article of manufacture to determine and communicate the redistribution of product demand whenever a new target product is added to, or an existing target product is deleted from an assortment of products. Additionally, the present invention involves a system, method and article of manufacture that optimizes inventory and inventory investment utilization based upon cost, lost sales, profit, and sales volume with or without considering investment constraints. Moreover, the present invention involves a method that enables economic bidding between retailers and suppliers of goods in categories containing branded, replenished items.

2. Known Art

As will be understood by those skilled in the art, efficient inventory control is a critical ingredient in the success or failure of many businesses. Since inventory maintained at a business facility is a primary cost of business, it is important that inventory levels and control be handled in a cost effective manner. Successful operations typically generate a positive return on their investment in such inventory with higher sales or fewer lost sales. Thus, methods of controlling inventory are of critical importance to a business enterprise.

Inventory control methods may be broadly categorized as either reactionary or preemptive. In the preemptive category, an inventory control person or manager (i.e., store managers, parts managers, quartermasters, comptrollers, controllers, chief financial officers, or other persons charged with maintaining inventory) tries to anticipate demand based on known criteria (i.e., changing seasons, approaching holidays, etc.). In the reactionary category, the inventory manager reacts to perceived shortages of existing inventory to address demand. The latter technique is typically employed by many retail businesses in daily operation.

Current replenishment models are centered on providing order quantities which simply offer a probability of being in stock during the replenishment cycle, but do not take into account the sum of holding cost and cost of lost sales due to stock outs. These systems project demand and store order quantities, but offer little or no insight into tradeoffs associated with the cost of carrying the inventory and the cost of stock outs.

Determining the quantities of product to carry on the shelf (facings) is typically a totally separate process from replenishment methods, and rule-of-thumb principles are often used to determine numbers of facings for products. Such heuristics consider product packaging practices, shelf days of supply, retailer shelving practices, or perhaps productivity measures such as profit per square foot, but none take into account both expected inventory holding costs and the expected cost of lost sales.

Several methods for measuring the perceived shortages of inventory have been developed. For example, U.S. Pat. No. 5,608,621, to Caveney et al. entitled System and Method for Controlling the Number of Units of Parts in an Inventory discusses a system for inventory management. The goal of the system is to optimize inventory based upon a selected inventory investment or service level constraint. In other words, this system optimizes inventory based on either a limited quantity of money or a time period for reordering parts during shortages.

Others have also addressed inventory control. Examples of general relevance include Baker, R. C. and Timothy L. Urban (1988). A Deterministic Inventory System with an Inventory-Level-Dependent Demand Rate, @ Journal of the Operational Research Society, 39(9): 823-831; Corstjens, Marcel and Peter Doyle (1981). A Model for Optimizing Retail Space Allocations, @ Management Science, 27(7): 822-833; Urban, Glen L. (1969). A Mathematical Modeling Approach to Product Line Decisions, @ Journal of Marketing Research, 6(1): 40-47; and, Urban, Timothy L. (1998). An Inventory-Theoretic Approach to Product Assortment and Shelf-Space Allocation, @ Journal of Retailing, 74(1): 15-35. The approaches proposed by these authors are of general relevance.

Another approach to inventory management called merchandise optimization determines the optimal product assortment and number of facings for each product based on a variety of objectives including minimizing the sum of expected annual inventory holding cost and expected annual cost of lost sales, maximizing gross margin, and maximizing unit sales. Inventory holding costs are primarily the opportunity cost associated with having a dollar invested in inventory instead of some other alternative. Inventory holding costs also include other variable costs associated with holding inventory. The expected annual cost of lost sales includes the costs associated with shortages or outages of a particular item.

As more space or facings are given to a particular item or stock-keeping-unit (a.k.a., SKU), the inventory of the SKU increases as does the physical space required to store the SKU in the facility (i.e., the shelf, warehouse space, etc.). Also, as the inventory of a particular SKU increases, the probability of a shortage or stockout during a given period of time decreases but the required annual shelf inventory level increases. Lower stockout probabilities translate into lower expected annual cost of lost sales. In a space-unconstrained environment, it would be optimal to select the number of facings that either minimizes total cost, the sum of expected annual cost of lost sales and expected annual inventory holding cost, or maximizes the economic profit, the difference between unit sales times margin and total cost, for each SKU individually. However, in most cases there is a fixed amount of space available for inventory. Consequently, it is necessary to find the product assortment and optimal number of facings for each SKU being evaluated that is optimal for all SKUs as a whole. This optimum can be determined with respect to a wide range of business objectives.

Thus, a need exists for an improved inventory control system. In particular, a need exits for an improved system that performs merchandise optimization using a variety of objective functions.

Furthermore, shelf layout impacts and is impacted by a wide variety of functions within retailers and suppliers. The decisions regarding shelf layout and the success of a particular layout are interrelated with, on the retail side, store operations, space planning, buying, and store replenishment; and on the supply side, packaging, marketing, sales, category management, and research and development. However, planning within these functions happens independent of consideration of the impact at the shelf level. Additionally, retailers and suppliers each have information the other does not have. Some of this information can be shared, with great benefit to the other party, without harming the information owner.

Similar interdependency of functions and potential for value in shared knowledge occurs farther up the supply chain. Efforts have been made to increase value through collaboration between suppliers, manufactures, and distributors. Specifically, there has been success in generating distribution center forecasts, determining replenishment quantities, reducing inventory investment, and operating costs. These gains through collaboration have not been applied to the shelf level, however.

Thus, a need exists for a system that facilitates collaboration at the shelf level between retailers and suppliers and between functions within each organization. In particular, a need exists for a system that facilitates merchandise optimization that includes the input of impacted parties.

The present invention may be advantageously employed to determine and communicate a redistributed product demand in two instances: (1) whenever a new product is to be added to an assortment of products and (2) whenever an existing product is removed from such an assortment. In the first instance, when planning for the addition of a new item, some amount of the demand for the item will be cannibalized from existing items in the assortment, and some of the demand will be new to the product assortment. In the latter instance, when planning for an item deletion, some of the demand for the item will be transferred to other items in a focus product assortment and some of the demand will be removed when the target item is no longer available. As used herein the terms “item” and “product” are used interchangeably. The term “target product” as used herein relates to the product item, or items to be added to, or deleted from, an assortment of products, while the term “focus product” or “focus products” relate to the assortment of products affected by said target product's deletion or addition.

Thus, a need exists for an improved product redistribution system, method and article of manufacture. In particular, an improved system, method and article of manufacture that is capable of determining and communicating redistributed product demand whenever a new product is added to, or an existing product is deleted from an assortment of products.

In addition to retail stores and their suppliers, there are other entities in the retail industry for which efficient inventory control is a key component of success. Even though on-line retailers do not have customers making purchase selections off of physical shelves, they are dramatically impacted by stockouts and product assortment decisions. The key difference between retail stores and on-line retailer sites is that investment rather than space is the primary constraint in the operation of an on-line retail site.

Conventional studies of on-line consumer behavior have shown that the number three reason for on-line purchase failure was stockouts. It is thus obvious that such failures can be very costly. Additionally, studies found that 51% of consumers who experienced a failed purchase attempt stopped shopping or purchasing at that site and six percent stopped shopping at that particular site's offline store.

Intertwined with the issue of stockouts is the issue of product assortment. The proliferation of assortment breadth (the number of categories) and depth (the number of SKUs in a category) are both alluring for an on-line retailer. It seems relatively easy to add new products and assortment categories to a web site. However, the total inventory investment required to achieve a given in-stock probability increases exponentially as assortment breadth and depth increase. Conversely, if the inventory investment is constrained, then stockouts will increase as assortment depth and breadth increase. Thus inventory investment is a key factor in making assortment decisions to meet consumer demand.

Just as current replenishment models often fail to meet the needs of store retailers, such methods do not provide the insights into tradeoffs between the cost of carrying inventory and the cost of stockouts that on-line retailers need. Further, the heuristics for determining product quantities are often based on space, something that is not of primary concern in the on-line retailing environment. Additionally, U.S. Pat. No. 5,618,621 by Caveney et al., mentioned earlier, discloses a system for inventory management where an inventory of parts can be optimized based on a limited quantity of money. However, optimizing an inventory of parts is very different from optimizing an inventory of retail products due to the differences in demand.

U.S. Pat. No. 5,946,662, to Ettl et al. discusses the optimization of inventory in the entire supply chain. While the method disclosed does consider the tradeoff between service level and the cost of holding inventory, inventory is optimized at the supply chain level, not the store or site level. This difference in scope makes this method inappropriate for application to an on-line retail environment. The method Ettl et al. disclose optimizes inventory quantities to fill aggregated demand and the results are applied at the warehouse level. No attention is given to site or store level concerns like consumer level response to stockouts and product assortment.

In U.S. Pat. No. 5,615,109, Jeff Eder shows an inventory control method and system. A portion of this method and system involves developing profit maximizing requisition sets that are feasible under forecast financial conditions. These requisition sets meet user defined fill rates for a user specified product assortment. The system checks that the minimum financial level is available for basic requisitions at all points in the forecast, and then provides a prioritized list of profit enhancing changes that would enable the user to make use of vendor volume discount programs. This method and system is focused on verifying ability to procure products the user has already selected, with options that may maximize profit. It does not address the on-line retailer's need to make consumer focused product assortment decisions given an available investment for inventory.

Thus, a need exists for an improved inventory control system. In particular, a need exits for an improved system that considers the impact of stockouts and the cost of holding inventory, while optimizing with respect to a wide range of objectives and the constraint of inventory investment.

For on-line retailers, third-party drop shipments have been considered as one answer to the high cost of holding inventory. With drop shipments, a distributor or manufacturer holds some inventory for the on-line retailer and ships it directly to the consumer or the on-line retailer upon consumer order. This allows the on-line retailer to avoid maintaining inventory of the item, but the order fulfillment process becomes more complex, control over delivery time is lost, and delivery times can be longer than consumers expect, creating dissatisfaction or purchase failures. For third-party drop shipments to be a viable option for on-line retailers, they must be able to choose the appropriate items and work closely with the suppliers.

Furthermore, on-line retailers would benefit from close communication with suppliers in areas beyond drop shipments. The target stock level (the assortment and amount of items to carry) impacts and is impacted by a wide variety of functions within on-line retailers and suppliers. The decisions regarding target stock level and the success of a particular combination of items are interrelated with, on the on-line retail side, distribution center operations, investment planning, buying, and replenishment; and on the supply side, packaging, marketing, sales, category management, and research and development. However, planning within these functions happens independent of consideration of the impact on target stock level. Additionally, on-line retailers and suppliers each have information the other does not have. Some of this information can be shared, with great benefit to the other party, without harming the information owner.

As mentioned earlier, collaboration has been given some attention in the retail industry. Interdependency of functions and potential for value in shared knowledge that occurs between functions within on-line retailers and between on-line retailers and suppliers occurs farther up the supply chain as well. Efforts have been made to increase value through collaboration between suppliers, manufactures, and distributors. Specifically, there has been success in generating distribution center forecasts, determining replenishment quantities, reducing inventory investment, and operating costs. These gains through collaboration have not been applied to the operation of on-line retail sites, however.

Thus, a need exists for a system that facilitates collaboration between on-line retailers and suppliers and between functions within each organization. In particular, a need exists for a system that addresses on-line retail inventory issues while facilitating inclusion of the input of impacted parties.

The bidding process as described herein typically includes two or more sellers and one buyer in a dynamic decision making situation. That means that several sellers are “bidding” for the business of the buyer. In some cases sellers create multiple bids and buyers accept sets of bids from the sellers. For the bidding process disclosed herein, the seller is the supplier of the goods while the buyer is the retailer.

Bidding processes are common for retailers doing business with suppliers of items that are not branded, and are not replenished. Bidding processes are not common, however, for items that are branded, stable, and replenished or similar private label products. Instead, negotiations over the cost of the item, assortment, and the terms of sale occur between retailers and suppliers. Over time, additional negotiations may occur, especially over new items or when the supplier attempts to increase the cost or when the retailer attempts to obtain price reductions. Often separately, negotiations occur over assortment, new item introductions, and promotions. This type of process is often referred to as “haggling” because there is only one seller and one buyer. Nevertheless, there is often an attempt by the buyer (retailer) to create competition between the suppliers for space, assortment, positioning, promotions, et cetera. However, the process is very informal, inefficient, and comparisons of economic offers are very difficult. The term “economic” is used herein to denote that there are more variables than just cost involved in an offer or bid. Further, the results of such attempts to create competition are not directly integrated into the utilization of merchandising space or inventory investment, though the impact can be dramatic.

There is a great deal of literature on bidding, as this has been a common practice in business and a common topic in economics study and research. However, none of the literature addresses suppliers bidding for retailers' shelf space or inventory investment, a key point in the supply chain.

U.S. Pat. No. 5,953,707, to Huang et al. discloses “a decision support system for the management of an agile supply chain”, a portion of which addresses Vendor Managed Replenishment (VMR). This is different from the current invention in several ways. For example, the VMR system uses a vendor-initiated process whereas the present invention uses a retailer-initiated process. Further, the focus of the VMR system is enabling key replenishment decisions on the part of the vendor whereas the present invention is focused on the objective identified by the retailer, though replenishment is a variable in the process. Also, the VMR system is designed for use by a single manufacturer as part of a larger system whereas the present invention enables simultaneous use by multiple suppliers for participation in a given retailer's scenario.

The following patents are of general relevance. U.S. Pat. No. 6,044,361 to Kalagnanam et al. and U.S. Pat. No. 5,963,918 to Reagan et al. apply optimization in the process industry. U.S. Pat. Nos. 5,241,465 to Oba et al., 5,845,582 to Kennedy, and 5,630,070 to Dietrich et al. address automated scheduling, automated business management planning, and optimal manufacturing resource planning respectively. U.S. Pat. No. 5,600,555 to Takahashi et al. shows a parts arrangement optimizing method and U.S. Pat. No. 5,611,051 to Pirelli involves automating replenishment for supply storerooms. None of the above patents address the retail industry.

U.S. Pat. No. 5,946,662 to Ettl et al and U.S. Pat. No. 3,705,410 to Kooy et al. include supply chain inventory optimization and warehouse space optimization respectively, but do not reach to the store level in any detail.

U.S. Pat. No. 4,947,322 to Tenma et al. discloses a method for planning the layout of goods in a retail environment. U.S. Pat. No. 5,241,467 to Failing et al. discloses a method for identifying the location and price of inventory in a store and enabling efficient audits. While the last two patents address planning and execution at the retail shelf, they do not address supplier bidding for use of the retail shelf.

Thus, a need exists for an improved method for retailers to create competition between suppliers of goods in branded, replenished categories. In particular, a need exists for an improved method that moves the haggle process, which is very subjective, to an economic bidding process that is objective and where the forces of competition create optimal solutions.

### BRIEF SUMMARY OF THE INVENTION

The present invention addresses the above referenced needs. In one exemplary embodiment, the system includes a server processor with memory, an optimizer database, and an optimizing process; at least one client processor with input, processing, memory, and output capability and local data; and a method for network access. The process optimizes inventory or store facings using various data and extrapolated computations. The user may employ the system to obtain useful results for inventory optimization.

The system optimizes inventory using merchandise optimization. As mentioned previously, merchandise optimization is an approach to shelf inventory management that optimizes the number of facings of a product, as well as product assortment, based on a selection of objectives. The process of merchandise optimization requires the assimilation of relevant data for each particular item to be evaluated. The data to be collected include store-level point-of-sale (a.k.a., POS) data, frequency of shelf replenishment, lead time, variability of lead time, space available, space required per SKU, number of units per facing, cost to the retailer of one unit of SKU, price retailer receives for one unit of SKU, the inventory holding cost factor, and the unit cost of a lost sale. Store-level POS is used to measure the mean of daily sales and the variability of daily sales (a.k.a., standard deviation of demand). The system evaluates these variables when determining the optimal solution for an unconstrained space or a constrained space of a particular facility.

In another exemplary embodiment, the present invention also further evaluates the cost of a shortage or stockout per unit. When determining the cost of a stockout, the system may utilize either a default value or another value set by the user. The potential values that may be set by the user can represent historical costs or possible consumer reactions to the shortage (including switching to different products, brands or sizes, leaving the store, shopping there less frequently, or never shopping there again). The percentage of customers who take each of these actions can be determined by marketing research or through logical discourse or through archival data. The default unit cost of a lost sale can merely be the margin of the item or some other more representative number.

The system further evaluates sales variability. This variability can be important if two SKUs have the same days-of-supply (a.k.a., DOS, calculated by taking the inventory level and dividing it by the volume of sales per day) on the shelf. The SKU with the higher sales variability will have a higher probability of stockout.

Additionally, the present invention considers variability of lead-time, the time between placement of an order and its arrival on the shelf. Like sales variability, lead-time variability can be important if two SKUs have the same days-of-supply on the shelf. The SKU with the higher lead-time variability will have a higher probability of stockout.

In another exemplary embodiment for collaboration, the system is as described above with at least two client processors. The system thus provides for collaboration between multiple suppliers and retailers. As a result, the various parties may collaborate their efforts to optimize inventory and maximize profits.

In an exemplary embodiment, the system includes a bank of memory, a processor, an input and an output, and a computer program. The system determines and communicates redistributed product demand using various data models and software technology computations. As used herein, the term “anticipates” is used synonymously with “projects” and “models” and generally recognized derivatives thereof.

In an additional exemplary embodiment for on-line retailers, the system, as described in the first embodiment, optimizes inventory using a variation of merchandise optimization that optimizes product assortment and the number of facings or order lots of a product. The system evaluates user input data using extrapolated computations to determine the optimal solution for an unconstrained inventory investment or a constrained inventory investment.

A further exemplary embodiment of the present invention enables an economic bidding process between a retailer and several suppliers in a category or segment containing branded, replenished items and related private label items. This process enables a retailer's acquisition, evaluation, and comparison of economic bids from multiple suppliers through the optimization and collaboration technology in the previous embodiments. Speed and timing are critical in the retail supply chain. The economic bidding process allows decisions to be made at the right time, quickly, involving many different parties.

Thus, a principal object of the present invention is to provide an improved system for optimizing and controlling inventory to enable more efficient business management.

A basic object of the present invention is to provide an inventory optimization system that optimizes inventory using merchandise optimization.

Another basic object of the present invention is to provide an inventory optimization system that (1) minimizes the sum of expected annual cost of lost sales and expected annual inventory holding cost, (2) maximizes economic profit, (3) maximizes unit sales, (4) maximizes sales revenue, (5) maximizes gross margin, or (6) optimizes with respect to any weighted combination of the preceding five objectives.

Another object of the present invention is to provide a system that evaluates the cost of a shortage when determining optimal inventory.

Yet another object of the present invention is to provide a system that optimizes inventory for an unconstrained space.

Yet another object of the present invention is to provide a system that optimizes inventory for a constrained space.

An additional object of the present invention is to provide an inventory optimization system that evaluates sales variability.

A further object of the present invention is to provide an inventory optimization system that evaluates replenishment lead-time variability.

Another basic object of the present invention is to provide a merchandise optimization system that can be utilized to evaluate new products and/or remove existing products from inventory.

Yet another object of the present invention is to provide an inventory optimization system that can be utilized to evaluate the number of unique SKUs in a category.

An additional object of the present invention is to provide an inventory optimization system that can be utilized to evaluate shelf level presentation requirements (case packs, inner packs, blocking, and presentation packs).

Another basic object of the present invention is to provide an inventory optimization system that will allow for all of the above objectives in a collaborative environment between multiple suppliers and retailers.

An additional basic object of the present invention is to provide an improved system, method and article of manufacture for determining and communicating redistributed product demand using various data and software modeling computations.

Yet another object of the present invention is to provide a system that optimizes inventory for an unconstrained inventory investment.

An additional object of the present invention is to provide a system that optimizes inventory for a constrained inventory investment.

A further object of the present invention is to provide a method for economic bidding between retailers and their suppliers for goods in branded, replenished categories.

### BRIEF DESCRIPTION OF THE DRAWINGS

FIG. 1 is a block diagram illustrating a preferred computer system of an exemplary embodiment of the present invention.

FIG. 2 is a flow diagram illustrating the general operation of one embodiment of the instant invention.

FIG. 3 is an illustration of a representative graphical user interface used for importing data required for the optimization analysis.

FIG. 4 is an illustration of a representative graphical user interface used for mapping the data fields in the import file to the data fields in the instant invention.

FIG. 5 is an illustration of a representative graphical user interface used for viewing data and selecting the subset of data for optimization.

FIG. 6 is a flow diagram illustrating the unconstrained optimization subroutine.

FIG. 7 is an illustration of a representative graphical user interface used for performing an unconstrained optimization to determine the absolute optimal solution.

FIG. 8 is a flow diagram illustrating the constrained optimization subroutine.

FIG. 9 is an illustration of a representative graphical user interface used for performing a constrained optimization to determine the optimal workable solution.

FIG. 10 is a flow diagram illustrating the collaboration process of another exemplary embodiment of the present invention.

FIG. 11 is an illustration of a representative graphical user interface used in creating a collaboration.

FIG. 12 is a flow chart which illustrating the logic sequence of the invention's preferred embodiment for redistributing demand whenever a target product is added to an assortment of products.

FIG. 13 is a non-limiting, representative Graphical User Interface for executing the invention's demand redistribution sequence whenever a target product is added to an assortment of products.

FIG. 14 is an expanded, non-limiting, representative Graphical User Interface for executing the invention's demand redistribution sequence whenever a target product is added to an assortment of products and a user has selected focus products to receive demand previously attributed to the target product.

FIG. 15 is a flow chart illustrating the logic sequence of the invention's preferred embodiment for redistributing demand whenever a target product is deleted from an assortment of products.

FIG. 16 is a non-limiting, representative Graphical User Interface for executing the invention's demand redistribution sequence whenever a target product is deleted from an assortment of products.

FIG. 17 is an expanded, non-limiting, representative Graphical User Interface for executing the invention's demand redistribution sequence whenever a target product is deleted from an assortment of products and consumer switching behavior has been used to select focus products to receive demand previously attributed to the target product.

FIG. 18 is an illustration of a representative graphical user interface of an alternative embodiment used for performing a constrained optimization to determine the optimal workable solution.

FIG. 19 is a flow diagram illustrating the constrained optimization subroutine of an alternative embodiment.

FIG. 20 is a flow diagram illustrating another exemplary embodiment of the present invention including an economic bidding process using parallel bidding.

FIG. 21 is a flow diagram illustrating another exemplary embodiment of the present invention including an economic bidding process using sequential bidding.

FIG. 22 is a flow diagram illustrating the supplier bid generation sub-process for the parallel and sequential bidding processes.

### DETAILED DESCRIPTION OF THE INVENTION

The present invention may be practiced in a client server configuration, a mainframe terminal configuration, or a personal computer network configuration including, but not limited to, wide area networks, local area networks, campus area networks, application service model, or indeed any combination thereof. All such configurations are well known by those reasonably skilled in the art.

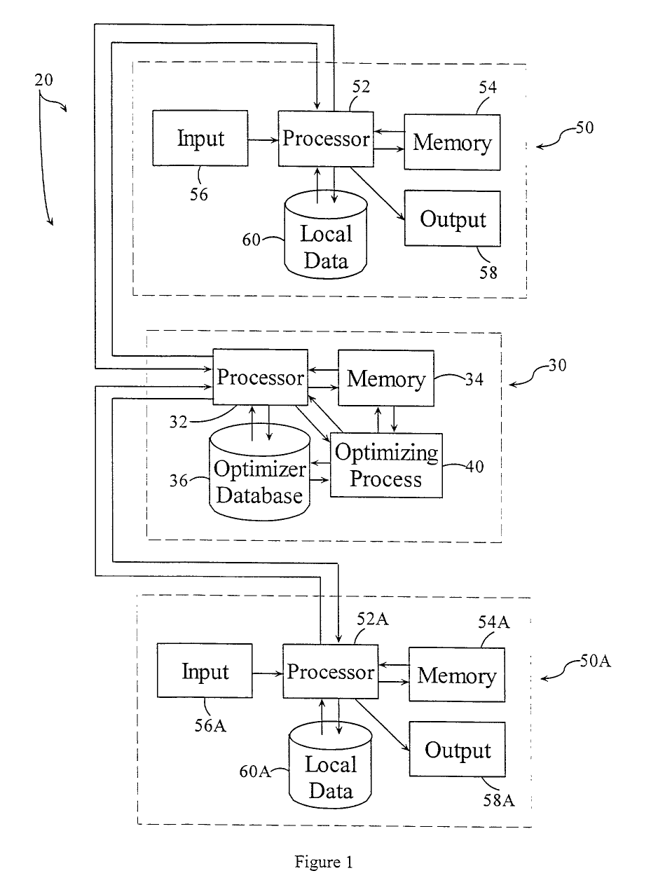

An exemplary embodiment of the present invention is illustrated in FIG. 1. This system 20 consists of a server 30 and at least one client 50. The server 30 consists of a processor 32 with memory 34, as well as an optimizer database 36 and an optimizing process 40. Each client 50 consists of a processor 52 with memory 54, input 56, and output 58, as well as local data 60. To perform merchandise optimization, only one client 50 is required. To perform collaboration, at least two clients 50, 50A must be involved in the optimization process and these clients interact through the server. It should be noted that multiple clients can access the server simultaneously.

The optimization process 40 of the present invention uses the local data 60 imported into the optimizer database 36 to enable a user to efficiently manage inventory for virtually any retail industry. The optimization process 40 may solve for the product set that offers the lowest possible total cost, highest possible economic profit, highest possible unit sales, highest possible sales revenue, highest possible gross margin, or a weighted combination of any of these objectives for the set of products being analyzed. This process 40 can be performed, for the first two objectives, in both unconstrained and constrained modes. The process for the remaining objectives can be performed in constrained mode only. In the unconstrained mode, the solution that is provided does not take into account physical space constraints. In the constrained mode, the solution that is provided takes into account the amount of space available for the product set and may delete an item if that improves the solution. In either mode, the proposed optimal solution is expressed in numbers of facings of the products or in optimal shelf inventory level. Comparisons between the current number of facings and the optimal number of facings by product yield cost savings of the proposed set of products over the current set of products.

In another exemplary embodiment, the optimization process 40 enables collaboration between retailers and suppliers in making shelf layout and product assortment decisions. Collaboration is enabled through this invention by allowing users to invite others into a collaboration, share scenarios, and permission data. The participants can adjust the data they have access to, as well as optimization parameters and constraints to reoptimize to meet their objectives. These new scenarios are shared with the collaboration initiator, who continues the process of evaluation, reoptimization, and collaboration until a decision is reached.

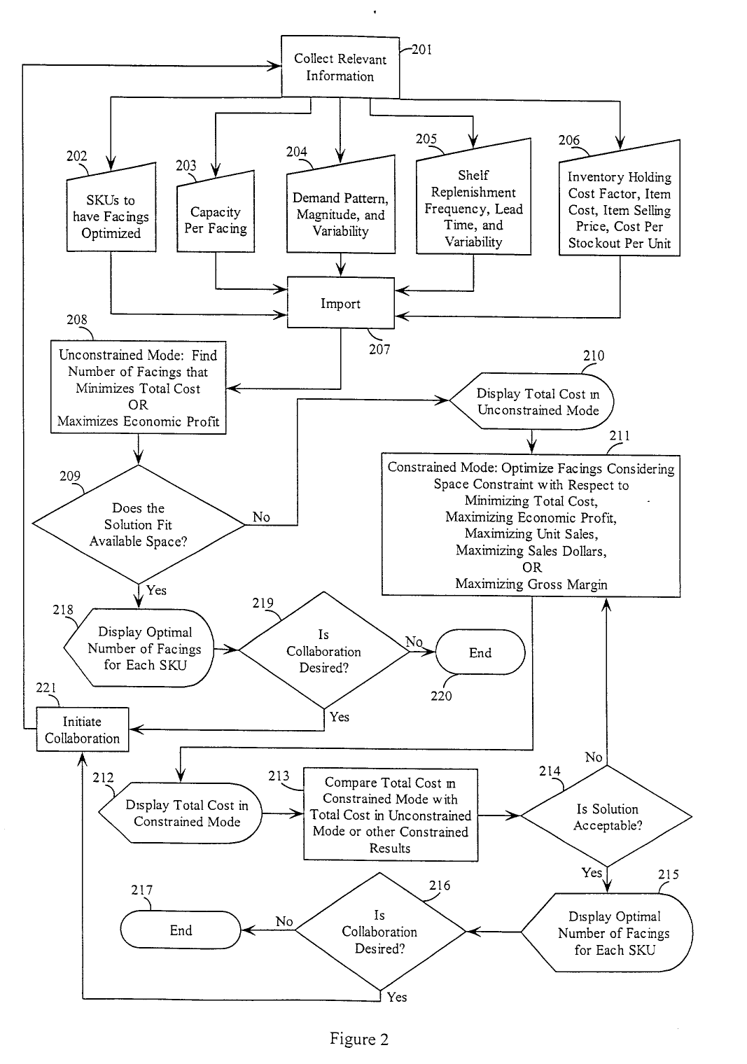

FIG. 2 is a logic flow diagram illustrating the general operation of the present invention. The first step in performing the optimization is to collect the relevant information at step 207 necessary for the optimization process 40. Such relevant information includes but is not limited to determining the SKUs to be optimized at step 202, the capacity per facing at step 203, the demand pattern, magnitude, and variability at step 204, determining shelf replenishment frequency, lead time, and lead time variability at step 205, and determining inventory holding cost factor per item, item cost, item selling price, and cost per stock out per unit at step 206. This data must then be imported into the system at step 207.

Having determined, collected, and imported the above stated information, the next step in the optimization process is to determine the number of facings that either minimizes total cost (the sum of expected annual costs of lost sales and the expected annual inventory holding cost) or maximizes economic profit (the difference between unit sales times margin and total cost) at step 208 depending on the choice of the user. Having made the determination of the number of facings that minimizes or maximizes the objective value at step 208, the next step in the optimization system is to query whether the solution provided fits the available space for such facings at step 209. Should the solution provided not fit the available space, the next step in the system is to display the total cost in an unconstrained mode at step 210.

Once the total cost associated with the unconstrained mode has been determined, the system next optimizes facings and product assortment considering space constraints using the constrained optimization mode at step 211. The constrained mode is performed, at the choice of the user, to optimize any of the following objectives: (1) minimize total cost, (2) maximize economic profit, (3) maximize unit sales, (4) maximize sales revenue, (5) maximize gross margin, or (6) a weighted combination of any of the preceding objectives. Having optimized facings and assortment based on the constrained optimization mode, the system next displays the total cost of the constrained mode solution at step 212 and then compares total cost in constrained mode with total cost in unconstrained mode or other constrained results at step 213. Once the total cost in constrained mode has been compared with total cost of other solutions, determination is next made as to whether the solution is acceptable at step 214. If the solution is found to be acceptable the optimal number of facings for each SKU is displayed at step 215.

At this point, the user must determine whether or not to enter into collaboration at step 216. If no collaboration is desired, the process reaches a normal conclusion at step 217. If collaboration is desired, a collaboration is initiated at step 221 and the entire process begins again with the collection of additional data at step 201 for each of the collaborators.

Should the solution provided by comparing total cost in constrained mode with total cost in other solutions at step 213 be found not acceptable, a looping process is initiated whereby the next step in the system's execution would be to optimize facings and assortment considering space constraints using the constrained optimization mode at step 211, displaying the total cost in constrained mode at step 212, comparing the total cost at step 213, and again testing for the acceptableness of the solution at step 214. This process is repeated until an acceptable solution is reached and the process proceeds as described above.

In determining whether the solution fits the available space in step 209, should the system find that the solution does fit the available space, the optimal number of facings for each SKU is displayed at that point at step 218. Determination as to the desirability of collaboration must be made at step 219. If no collaboration is desired, the system terminates normally at step 220 thus bypassing any need to calculate and display total cost in the constrained optimized mode at steps 211, 212. If collaboration is desired, a collaboration is initiated at step 221 and the process repeats, beginning with the collaborators collecting additional information at step 201.

There are several features of this invention that make it an accurate and effective tool for aiding inventory decisions that involve uncertainty. The present invention takes into account two crucial types of variability. Both sales variability and the variability of lead-time, where lead-time is the time between placement of an order and its arrival on the shelf, can dramatically impact the effectiveness of a solution. These are critical factors to consider because two SKUs can have the same days-of-supply (a.k.a., DOS, calculated by taking the inventory level and dividing it by the volume of sales per day) on the shelf and the one with the higher variability, in either sales or lead time, will have a higher probability of stockout.

A detailed discussion of each step in the process of the present invention follows.

### DATA COLLECTION

The process of the present invention requires data collection at step 201. This data includes store-level point-of-sale (a.k.a., POS) data, frequency of shelf replenishment, lead time, standard deviation of lead time, space available, space required per SKU, number of units per facing, cost to the retailer of one unit of SKU, product price, the inventory holding cost factor, and the unit cost of a lost sale. Store-level POS is used to measure the mean of daily sales and the variability of daily sales (a.k.a., standard deviation of demand). The software takes all of these variables into consideration in finding the optimal solution. The following specifies the direction of the relationship between each of the variables and the required number of facings.

| | |
|---|---|
| Positive | mean of POS |
| Positive | standard deviation of POS |
| Negative | frequency of shelf replenishment |
| Positive | shelf-level order cycle time |
| Negative | number of units per facing |
| Negative | cost to the retailer of one unit of SKU |
| Positive | price retailer receives for one unit of SKU |
| Negative | inventory holding cost factor |

The data required for the analysis is collected prior to running an optimization in either a constrained or unconstrained mode. Spreadsheets, CSV files, and tab delimited text files assembled using Microsoft Excel have been found to work well but other programs can be used as desired. Other data elements may be required depending upon the parameter settings of the optimization.

There are two types of data collections that can be imported into the optimizer database 36. The first, entity data, contains detail on each SKU that is to be analyzed. The second, demand data, contains weekly or daily demand information that will be transformed into model inputs.

Entity data will be discussed first. The user collects the following entity data elements for input into the optimizer database 40. There will be one record per item with as much data as desired by the user filled in. Specific column names are not required, nor are specific column locations, for the data elements in the spreadsheet or flat file. The columns of data can be in any order as the import function maps the spreadsheet/file columns to database fields in the import step. The following data may be contained in an entity data file.

Item Identification

UPC (at least one identifier required)

SKU (at least one identifier required)

Item Number (at least one identifier required)

Brand

Size

Description

Location

Manufacturer

Category

Segment

Sub-Segment

Status

Item Characteristics

Average Daily Demand (required)

Standard Deviation of Demand (required)

Time Between Replenishment (required)

Lead Time (time from when product is ordered until it is placed on shelf) (required)

Standard Deviation of Lead Time

Current Number of Facings (required)

Holding Capacity Per Facing (required)

Inventory Holding Cost Factor as a percentage of the items value (required)

Cost retailer pays for the item (required)

Price retailer is paid for the item (required)

Width of a facing (required)

Depth of an item

Height of a facing (if item is stacked, this is the stacked height)

Shelf Number

Sequence

Item Level Constraint Parameters

Assortment Override

Units Per Case

Units Per Inner Pack

Minimum Case Pack Quantity

Minimum Inner Pack Quantity

Force a minimum number of cases or inner packs

Equal Facings ID

Force an equal number of facings for identified items

Fixed Facing Quantity

Force a fixed number of facings

Maximum Days of Supply Quantity

Force a maximum number of days of supply

Minimum Days of Supply Quantity

Force a minimum number of days of supply

Minimum Service Level Percentage

Service Level Method

Force a minimum level of service

Cost of Lost Sales Parameters

Stockout Cost Method (Gross Margin, Contribution Margin, Known Margin, or Consumer Response)

Contribution Margin Factor

Consumer Response Factor

Gross Margin Factor

Known Margin

Percentage of Consumers who will Go to a Competitor when confronted with a stockout

Percentage of Consumers who will Never Buy the Product Again when confronted with a stockout

Percentage of Consumers who will Never Shop the Store Again when confronted with a stockout

Percentage of Consumers who will make No Purchase when confronted with a stockout

Percentage of Consumers who will Shop the Store Less Frequency when confronted with a stockout

Percentage of Consumers who will Switch Brand when confronted with a stockout

Percentage of Consumers who will Switch Product when confronted wit a stockout

Percentage of Consumers who will Switch Size when confronted with a stockout

Average Basket Profit

Average Shopping Trips Per Week

Shopping Reduction Percentage

Other Brand Margin

Other Product Margin

Other Size Margin

Required Rate of Return

Distribution Center Inventory Cost

Distribution Center Labor Cost

Distribution Center Occupancy Cost

Store Inventory Cost

Store Labor Cost

Store Occupancy Cost

Transportation Cost

Demand data can be collected as part of the entity data or as a separate file. Demand data must be transformed to average daily demand and standard deviation of demand before being included with entity data. If a separate demand data file is used the import function performs the necessary transformations and updates the average daily demand and the standard deviation of demand in existing entities within the optimizer database. The data may be collected in a variety of formats, depending on the availability of data. Ideally, the user will collect daily demand per SKU for each store location as this enables the most accurate calculation of the standard deviation of demand. It is possible, however, to handle demand aggregated over a week and/or multiple store locations. The data may be formatted such that there is one row per product with multiple demand columns or multiple rows per product with one demand column. The demand data file must employ the same system for creating uniqueness between records as the entity file. The user may elect to use the demand data file to update item price as well.

### DATA IMPORT

Once the user has collected data, the next step is to import the data into the optimizer database 36. For both data file types, the import function without limitation consists of creating an import profile, indicating any required data transformations to be conducted during the import, selecting the import file, mapping the source data fields from the import file to the destination data fields and initiating the import process.

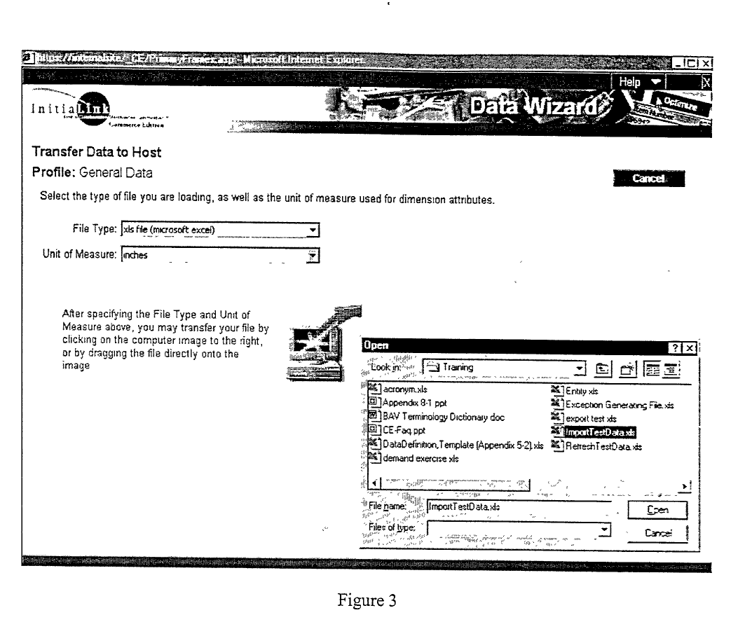

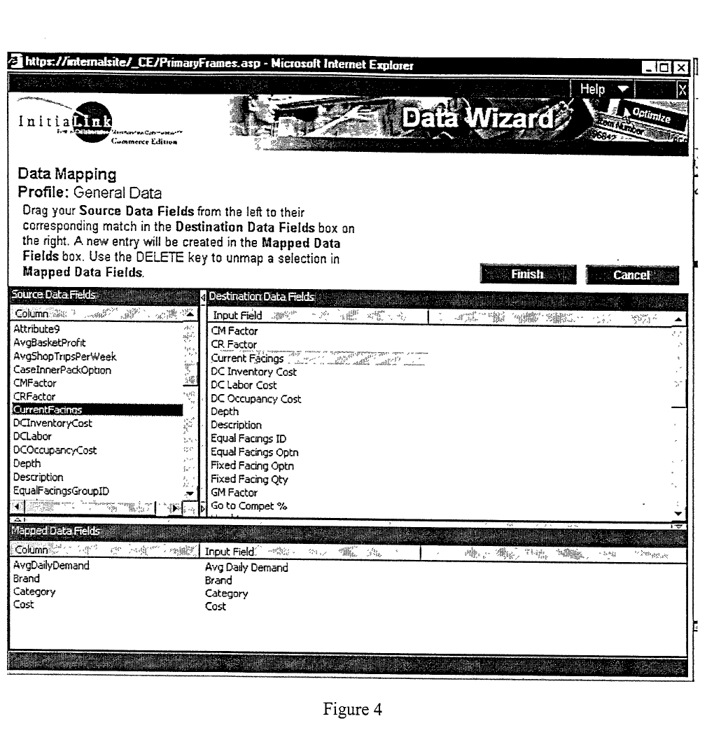

The import process reads each record in the input file, applies the data transformations, and appends (or updates) the record in the database. The database into which the records are imported is not unique to the design. The present invention uses a PC-based SQL-capable database to store the data, but other databases may be used. FIGS. 3 and 4 are examples of graphical user interfaces (a.k.a. GUIs) for the import process provided by the instant invention.

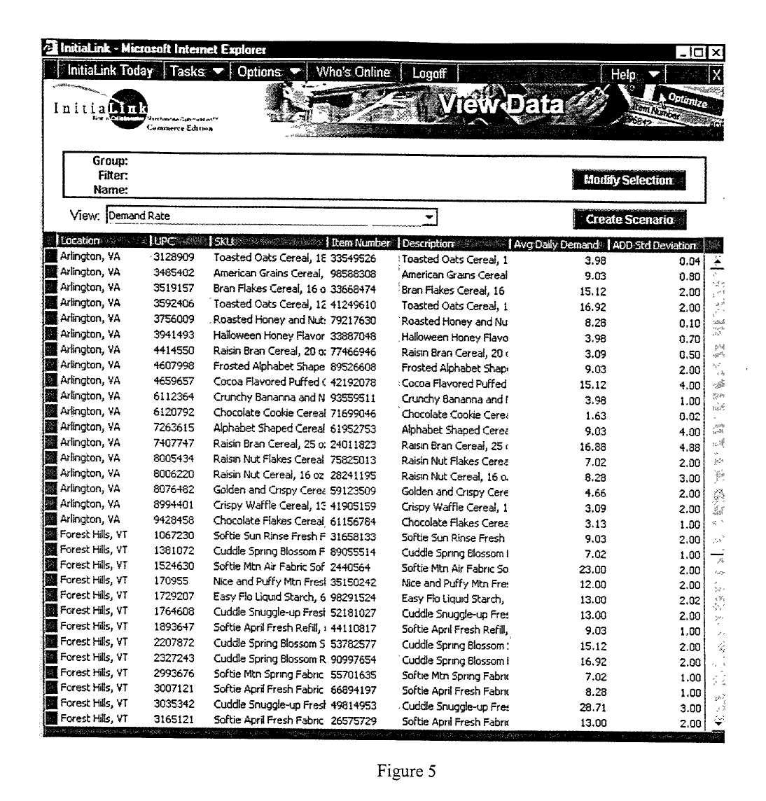

To begin the import process, the user makes a selection from the Tasks menu on the main tool bar (visible in FIGS. 5, 7, and 9) that starts the Data Wizard. The user names the profile and selects the type of data to load, entity data or demand data. Importing entity data will be discussed first. Once the user selects an entity data load type, he must choose the action to be performed by the import: (1) delete and insert, (2) insert, (3) update, or (4) insert and update. Then the GUI represented in FIG. 3 is brought up. In this screen, the user selects the file format and units of measure (inches, feet, or centimeters). All length units are converted to inches in the import process. Next, the user selects the file to import. At this point the user must map the data fields from the import file to the InitiaLink data fields. This mapping is done through the GUI represented in FIG. 4. To map the fields, the user clicks on a source data field (from the import file), drags the cursor over the corresponding destination data field (from InitiaLink), and releases the mouse. That mapping then appears in the list at the bottom of the screen showing the mapped data fields. When the mapping is complete, clicking the ‘Finish’ button initiates the import, records are appended or updated based on option selected, and the process is complete.

After naming the profile and selecting the type of data to load, the import of demand data varies from the import of entity data. Once demand is selected as the load type, the user must indicate whether demand and price data or demand data only is to be imported. The user must select the type of data to be imported: (1) daily data for multiple locations, (2) daily data for specific locations, (3) weekly data for multiple locations, or (4) weekly data for specific locations. The user must also enter several other parameters for the data transformation depending on the type of data and the format of the import file. The import transforms any of the data types mentioned above into average daily demand, standard deviation of demand, and price (if selected) for each SKU. At this point the user must map the input and InitiaLink fields in the same manner as discussed in the entity data import. Once the fields are mapped, clicking the ‘Finish’ button initiates the import, the existing entity records are updated where a match is found, and the process is complete.

### VIEWING AND EDITING DATA

Once data is in the optimizer database, it is visible through the View Data menu option in the Tasks menu in the main toolbar. This GUI, represented in FIG. 5, allows the user to view all the data by accessing, via selection in the ‘View’ drop down box, a variety of tables containing related data fields. For example, the ‘Demand Rate’ table allows the user to view average daily demand and standard deviation of demand and the ‘Replenishment’ table allows the users to view lead time, standard deviation of lead time, and time between replenishments fields.

There are two ways to modify any of the data elements contained in each record in the optimizer database. The user can import a modified file using the “update” option. The user can also edit each record individually from the View Data screen (FIG. 5). The item can be edited through the item detail window accessed by using the row header to select the entire row for the desired item, then right clicking and selecting Item Detail from the menu. The item detail window is split with the right side containing the item's descriptive fields and the left side containing four tab sheets with all other fields for the selected item. The first tab sheet contains replenishment, item and inventory holding cost, demand rate, shelf inventory, and product dimension data. The second tab sheet contains the data fields used to calculate the cost of a stockout. The third tab sheet contains fields for item level constraint parameters. The final tab sheet contains additional attribute fields for use as desired by the user. Many of these fields will be discussed further later in this document.

### DATA SUBSET CREATION

Prior to submitting the data for an optimization, the user may choose to filter the database to obtain a set of items relevant for the analysis. In actuality, the data has already been filtered for the user so that the user can only see items that have been authorized for him/her to see based on the user's ID and company information. Further selection of items from the database is accomplished by allowing the user to create groups, filters, or named lists. Groups and filters enable the user to create simple SQL-select-type statements to narrow down the items for analysis. Records can be grouped on descriptive elements like UPC code, item number, category/segment/subsegment descriptors, or location or filtered on numeric elements like cost, lead-time, margin, or width. Named lists enable the user to hand select a subset of items and give it a name for ease of reference and selection in the future.

A user accesses any of these selection methods through the ‘Modify Selection’ button on the View Data screen (FIG. 5). This button opens a window containing a tab sheet for each selection method. The first tab sheet enables the user to create groups of data with a set of data elements in common. The user creates a group by generating simple SQL-select-type equality statements. A selection rule is created by selecting the criteria data field from a drop-down list-box of available fields and its desired value from a drop-down list-box of valid values for that field. Grouping rules can be set using any of the text data fields. Rules can be used individually or in combination and can be added or removed by the click of a button. And the set of rules for the group can be named and saved for later use.

The second tab sheet enables the user to create a data filter. A filter is similar to a group, but where a group allows the user to specify criteria for text fields, a filter allows criteria based on numeric data fields. The user creates a filter by generating simple SQL-select-type statements. These statements use any numeric comparison operator: equality, inequality, and greater than or less than, with or without equality. A selection rule is created by selecting the criteria data field from a drop-down list-box of available fields, selecting the desired comparison operator, and entering the desired numeric criteria. Rules can be used individually or in combination and can be added or removed by the click of a button. And the set of rules for the filter can be named and saved for later use.

The third tab sheet enables the user to create a named list of selected data elements. To create a list, a user selects the desired items by hand, prior to entering the selection window, and then, once in the selection window, enters a name for the list. This named list is available as selection criteria in the future. When selecting the items, a user can hold down the Shift key to select a contiguous group of items, or hold down the Control key to select multiple individual items, as is common in many Microsoft Windows based applications.

Groups, filters, and named lists are applied with the click of the ‘OK’ button. This returns the user to the View Data screen (FIG. 5), where only the selected items are visible. The name of the group, filter, and/or named list being used appears in the box in the upper portion of the screen. Groups, filters, and named lists may be used individually or in combination. All saved selection methods can also be cleared or deleted from the selection window. Once a user has created a subset of data to analyze, merchandise optimization can be performed.

### OPTIMIZATION

Merchandise optimization is an approach to shelf inventory management that optimizes product assortment and number of facings for each product based on a variety of objectives. It should be noted that the term “shelf” is used in a general sense. The present invention may be used to optimize many types of retail space (freezers, peg boards, floor space, etc.) in addition to shelves.

Two optimization modes are provided for in the instant invention, the unconstrained and the constrained modes. The unconstrained optimization mode will return the absolute optimal solution for the SKUs in the analysis. In many cases, however, this solution is unworkable since it does not take into account the amount of shelf space available for the items. The solution returned may not fit in the available shelf space. This analysis is useful for determining an optimal benchmark for each item. It represents the solution that has, depending on the selection of the user, either the lowest possible total cost (the sum of expected cost of lost sales and expected inventory holding costs) or highest economic profit (the difference between unit sales times margin and total cost) without regard to the available shelf space.

However, in most cases there is a fixed amount of space available for a particular category. Consequently, it is necessary to forgo the optimal number of facings for individual SKUs and, instead, find the number of facings for each SKU that minimizes or maximizes the objective for the category as a whole. This is the constrained optimization, as provided for by the instant invention. In the constrained mode, optimization can be performed with respect to any one or a weighted combination of any of the following objectives: minimize total cost, maximize economic profit, maximize unit sales, maximize sales revenue, or maximize gross margin.

Inventory holding costs involved in several of the objective functions are primarily the opportunity cost associated with having a dollar wrapped up in inventory instead of some other alternative. Consequently, there needs to be a good return to inventory—i.e. higher sales or fewer lost sales. Inventory holding costs also include all other variable costs associated with holding one unit of inventory. Cost of lost sales is cost associated with a product being out of stock. This cost can be calculated by four methods: Gross Margin, Contribution Margin, Known Margin, and Consumer Reaction. These methods are discussed in further detail in the next section of the document.

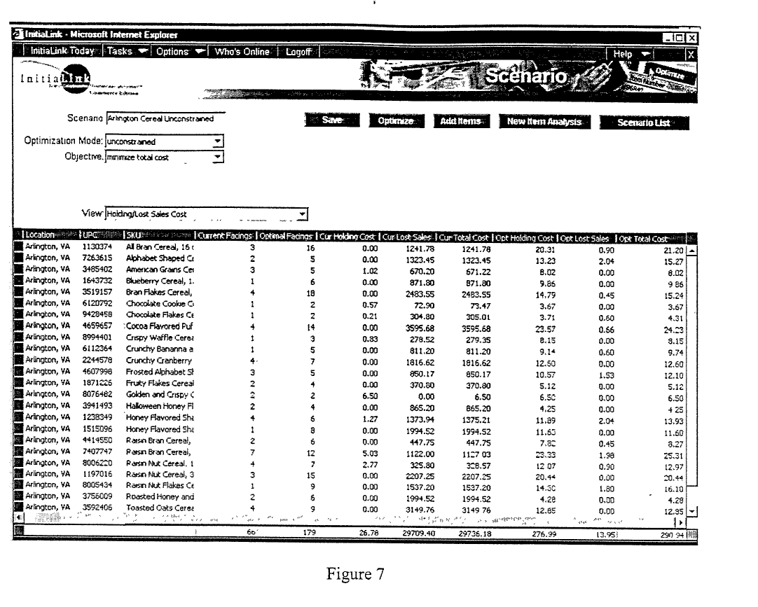

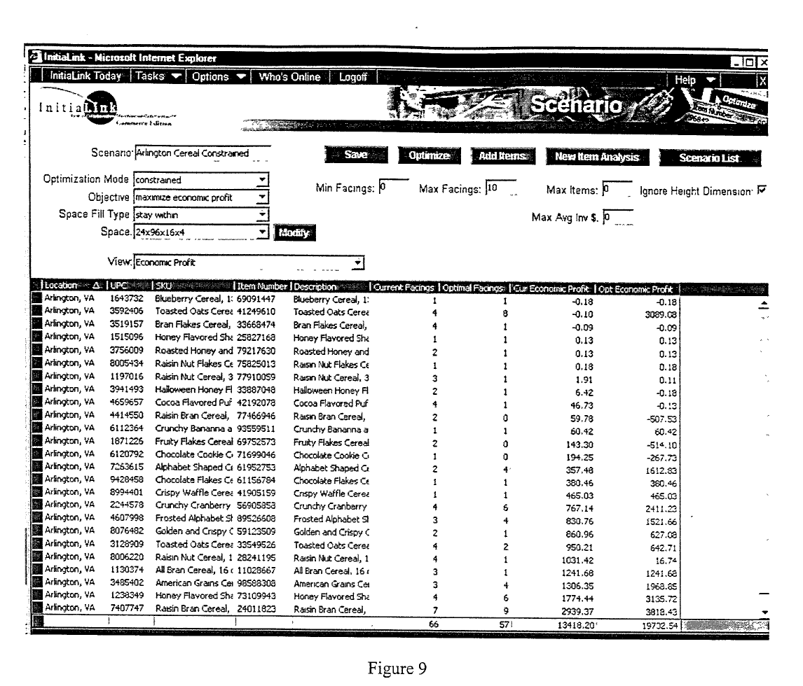

To perform either mode of optimization, the user must select the SKUs to be optimized, as discussed in the previous section. Then a scenario must be created by selecting a subset of data and clicking the ‘New Scenario’ button in the View Data window (FIG. 5) or by making a menu selection from the main tool bar (visible in FIGS. 7 and 9) which opens the Scenarios window, clicking the ‘New Scenario’ button and selecting a subset of data. Either method for creating a scenario opens an additional Scenario screen, where the user selects an optimization mode and an objective. The set of objectives are presented in a drop-down list-box component and the user must make a selection from the list that is provided. The selection of one of these objectives is a decision of the user. From the Scenario interface, the user also sets other optimization parameters and names, saves, and optimizes the scenario. Examples of the GUI provided by the instant invention are shown in FIGS. 7 and 9. Each mode of optimization is discussed in the upcoming sections.

### COST OF LOST SALES

In either mode of optimization, a key consideration in determining the optimal shelf layout is the cost of a stockout, or in other words, the cost of lost sales due to an out of stock for a particular product. The present invention calculates the cost of lost sales per unit and incorporates it into two of the objective functions: minimize total cost and maximize economic profit. The invention can be tailored to use any one of the following four methods of stock out cost per unit: gross margin (the default), contribution margin (gross margin less activity costs), a user-supplied known cost of stockout, or an estimated cost based on consumer reactions to stockouts. This final option considers such consumer reactions as switching to different brands, products or sizes, leaving the store, shopping there less frequently, or never shopping there again. The percentage of customers who take each of these actions can be determined by marketing research or through logical discourse or archival data. And these percentages, combined with several other parameters, are used to calculate an expected cost. All four cost of lost sales methods are discussed in further detail below.

The first method, Gross Margin, assumes the cost of a lost sale is the profit of the item, calculated by taking the difference between the item's selling price and the item's cost. This is a conservative approach to costing stockouts as it does not take into account the future effect on the consumer of being out of stock nor does it accommodate the user opting to switch to an alternative when confronted with a stockout.

The second method, Contribution Margin, is generally even more conservative than the Gross Margin since it uses the contribution margin of the item as the cost of a stockout. The contribution margin is calculated by subtracting some number of allocated costs from the gross margin.

The third method, Known Margin, allows the user to specify any dollar amount desired for the cost of a stockout. This method allows a user to employ a particular known stockout cost in the calculation.

The final method, Consumer Reaction, seems considerably more complex than the others because of the number of fields provided, but is actually easy to comprehend. This method allows you to use your consumers' known behaviors when confronted with stockouts to accurately calculate the cost of a stockout. By specifying the percentages of consumers who switch to an alternative, delay purchase, or go to competitors for the item, you can calculate the expected cost of a stockout in this item to use in the analysis. In most cases, this method will yield higher stockout costs than either the Gross Margin method or the Contribution Margin method. The following explains the calculation of the stockout cost constant using this method:

1. For each item in the analysis, collect data regarding percentage of consumers who will engage in one of eight possible actions when confronted with a stockout of the item:

| | POTENTIAL LOSS/GAIN TO THE |
|---|---|
| CONSUMER REACTION | RETAILER |
| Purchase an alternative product | Difference between profit of out of |
| | stock item and alternative item |
| Purchase the same product but in | Difference between profit of out of |
| a different size item | stock item and different size item(s) |
| Purchase the same product in a | Difference between profit of out of |
| different brand | stock item and different brand item |
| Delay purchase until later | Loss of profit of the item |
| Go to a competitor for the item | Loss of profit of the typical shopper's |
| | basket, not just the out of stock item |
| Shop the store less frequently | Loss of some percentage of profit of |
| | typical shopper's basket |
| Never buy the item again | Loss of profit of the item in |
| | perpetuity |
| Never shop the store again | Loss of the total of profit of the |
| | typical shopper's basket in perpetuity |

2. Collect the following data for each item in the analysis: profit of the typically chosen “alternative” product, profit of the typically chosen “other size” product(s), profit of the typically chosen “other brand” product, average profit per basket, average number of shopping trips per week for a typical consumer, the typical reduction percentage for consumers who shop the store less frequently as a result of a stockout, and the required rate of return on financial investment.

3. For each item in the analysis, calculate the profit loss/gain for each possible outcome:

| | POTENTIAL LOSS/GAIN TO THE |
|---|---|
| CONSUMER REACTION | RETAILER |
| Purchase an alternative product | Difference between profit of out of |
| | stock item and alternative product |
| | item |
| Purchase the same product but in | Difference between profit of out of |
| a different size | stock item and different size item |
| Purchase the same product in a | Difference between profit of out of |
| different brand | stock item and different brand item |
| Delay purchase until later | Profit of out of stock item |
| Go to the competitor for the item | Average profit per basket |
| Shop the store less frequently | Reduction in shopping percentage |
| | times profit per basket times average |
| | shopping trips per week times 52 |
| Never buy the item again | Profit of out of stock item times |
| | average shopping trips per week |
| | times 52 divided by required rate of |
| | return percentage |
| Never shop the store again | Average profit per basket times |
| | average shopping trips per week |
| | times 52 divided by required rate of |
| | return percentage |

4. Multiply the percentages from step 1 above by the loss/gain for each possible outcome from step 3 and sum the terms to calculate the total expected cost of lost sales for the item. When used in the calculation of cost of lost sales, this usually provides a more realistic estimate of stockout costs.

The cost of lost sales method is the choice of the user and depends on the data that is available to the user. The method selected impacts both modes of optimization. The optimization is directly impacted by the cost of lost sales method when either minimize total cost or maximize economic profit is chosen as the objective function.

### UNCONSTRAINED MODE

As more facings are given to a particular SKU, more inventory is allocated to the shelf. As SKU inventory is supplemented, the probability of a stockout in a given period of time decreases but the excepted annual shelf inventory level increases. Lower stockout probabilities translate to lower expected annual cost of lost sales. In an unconstrained environment, an optimal result, and an object of the present invention, is to select the number of facings that minimizes the sum of expected annual cost of lost sales and expected annual inventory holding cost, also called the total cost. Another optimal result, and another object of the invention, is to select the number of facings that maximizes economic profit, the difference between margin time's unit sales and total cost. The invention provides for both selections in its unconstrained routine. A category is optimized by optimizing each SKU individually, then combining the individual solutions to create the category solution. From the unconstrained optimal number of facings for each SKU in a category and the width of each facing, the optimal space for the category can be derived.

To perform optimization in the unconstrained mode, create a scenario as discussed in the previous section. In the Scenario window, select ‘unconstrained’ from the Optimization Mode drop-down list-box. (A sample GUI from the present invention is provided for example in FIG. 7.) Once the unconstrained mode is selected, the user selects an objective from the list, which has been limited to the appropriate unconstrained objectives, ‘minimize total cost’ and ‘maximize economic profit’. Clicking the ‘Optimize’ button initiates the unconstrained optimization.

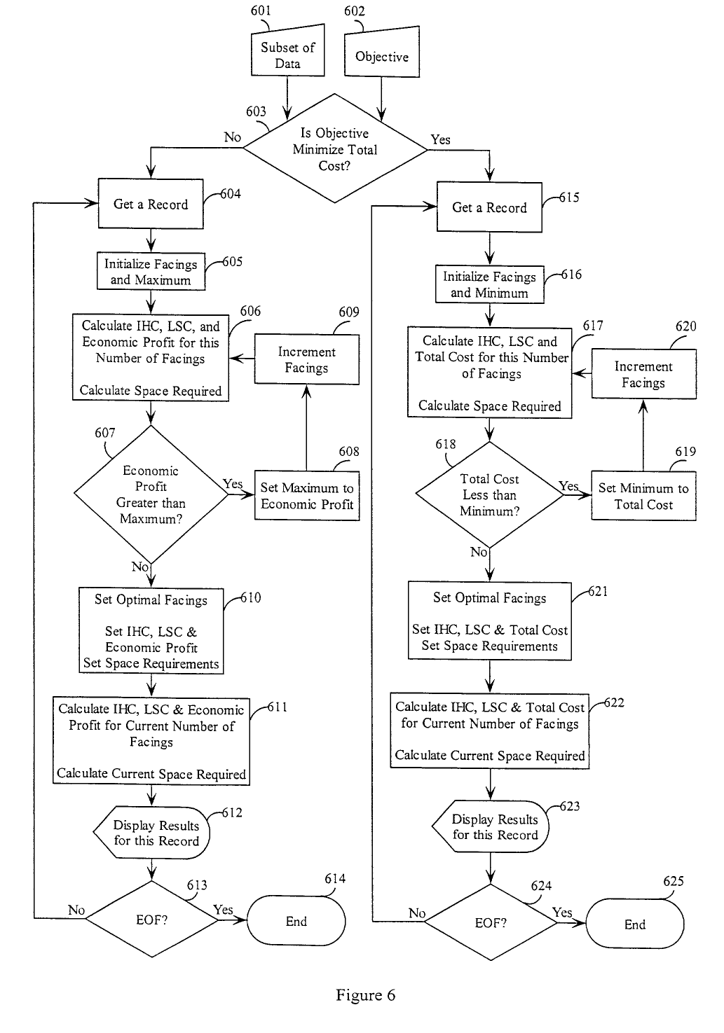

The Unconstrained Mode of merchandise optimization employs a “brute force” method for determining the optimal number of facings for each item. The process is illustrated in the flow diagram in FIG. 6. The unconstrained optimization process begins with the input of a user-selected subset of data at step 601 and a user selected objective function at step 602. The next step is to identify which objective function was selected 603. Since there are only two possible objective functions, if the objective is not minimize total cost, then it is maximize economic profit.

If the objective function is identified as maximize economic profit, the analysis begins by getting a record at step 604. Next, the number of facings is initialized to one and the Maximum is initialized to a very small number at step 605. The Inventory Holding Cost (IHC), Lost Sales Cost (LSC), Economic Profit, and the space required for the given number of facings are calculated at step 606. Then the Economic Profit is compared to the Maximum at step 607. If the Economic Profit at step 607 is greater than the Maximum a loop is entered. In the loop, the Maximum is set to the current Economic Profit at step 608, the number of facings is incremented at step 609, the metrics calculated for the new number of facings at step 606, and Economic Profit compared to Maximum at step 607. This loop continues until the Economic Profit is no longer greater than Maximum. At this point the number of facings that maximizes Economic Profit has been found. The optimal number of facings, IHC, LSC, Economic Profit, and space requirements are set at step 610. Then, to allow for comparison, IHC, LSC, Economic Profit, and space requirements are calculated for the user entered Current Number of Facings at step 611. After these calculations, the results are displayed for this record at step 612. The next step in the process is to test for the end of the file (EOF) at step 613. If there are still records in the file, the next record is selected at step 604 and the process repeats. Each record is processed in this manner until the end of the file is reached at step 613 and the process reaches a normal conclusion at step 614.

If the objective function is identified as minimize total cost, the process is very similar and begins with the retrieval of a record at step 615. Then the number of facings is initialized to one and the Minimum is initialized to a very large number at step 616. The Inventory Holding Cost (IHC), Lost Sales Cost (LSC), Total Cost, and the space required for the given number of facings are calculated at step 617. Then the Total Cost is compared to the Minimum at step 618. If the Total Cost is less than the Minimum a loop is entered. In the loop, the Minimum is set to Total Cost at step 619, the number of facings is incremented at step 620, the metrics calculated for the new number of facings at step 617, and Total Cost compared to Minimum at step 618. This loop continues until the Total Cost is no longer less than Minimum. At this point the number of facings that minimizes Total Cost has been found. The optimal number of facings, IHC, LSC, Total Cost, and space requirements are set at step 621. Then, to allow for comparison, IHC, LSC, Total Cost, and space requirements are calculated for the user entered Current Number of Facings at step 622. After these calculations the results are displayed for this record at step 623. The next step in the process is to test for the end of the file (EOF) at step 624. If there are still records in the file, the next record is selected at step 615 and the process repeats itself. Each record is processed in this manner until the end of the file is reached at step 624 and the process reaches a normal conclusion at step 625.

The key data from the user for the unconstrained optimization process is:

ADD≡Average Daily Demand

σ_{ADD}≡Standard Deviation of Demand

TBR≡Time Between Replenishment

LT≡Lead Time

σ_{LT}≡Standard Deviation of Lead Time

HCPF≡Holding Capacity per Facing

HCF≡Inventory Holding Cost Factor

C≡Cost retailer paid

P≡Price paid to retailer

w≡Width of a facing (in inches)

ACD≡Activity Cost Drivers, additional costs used in calculating the Contribution Margin (Distribution Center Inventory Cost, Distribution Center Labor Cost, Distribution Center Occupancy Cost, Store Inventory Cost, Store Labor Cost, Store Occupancy Cost, Transportation Cost)

Current Number of Facings

The terms that are calculated during the process are described in more detail below. Additional calculations are introduced as needed. Each calculation is performed for a specific number of facings for a particular item.

F≡number of facings for the item

IHC≡Inventory Holding Cost

IHC=AIL·C·HCF

AIL Average Inventory Level

AIL=CS+SS

CS≡Cycle Stock, the amount of inventory needed to satisfy demand during the replenishment period, TBR

$$CS = \frac{ADD \cdot TBR}{2}$$

SS≡Safety Stock, the amount of inventory needed to satisfy demand during the lead-time

If there is no variation in demand

SS=(HCPF·F)−(ADD·TBR)

If there is variation in demand

$$SS = ( {z}^{TBR + LT} ) \cdot ( {σ}_{ADD}^{TBR + LT} )$$

σ_{ADD}^{TBR+LT}≡Standard Deviation of Demand during the time between replenishments plus lead-time

$${σ}_{ADD}^{TBR + LT} = \sqrt{( TBR + LT ) \cdot {σ}_{ADD} + ( {ADD}^{2} \cdot {σ}_{LT}^{2} )}$$

z^{TBR+LT}≡Number of standard deviations during the time period of the time between replenishments plus lead-time for a certain level of probability

LSC≡Lost Sales Cost, the expected cost of stockouts for a year

LSC=UL·SOC

SOC≡Stockout Cost per Unit, based on the user defined Cost of Lost Sales method discussed in the previously in this document—Gross Margin, Contribution Margin, Known Margin, and Consumer Response.

UL≡Units Lost per year, the expected number of unit sales lost per year due to the item being out of stock

If there is no variation in demand

$$UL = ( ( ADD \cdot TBR ) - ( F \cdot HCPF ) ) \frac{365}{TBR}$$

If there is variation in demand

GM·US

E(z)≡Unit Loss integral of z

σ_{ADD}^{LT}≡Standard Deviation of Demand during the lead-time

subQ′=iniQ′+Q−d·TB

z^{LT}≡Number of standard deviations during the time period of the lead-time for a certain level of probability

EP≡Economic Profit, the true economic profit made by the retailer

EP=(US·M)−TC

US≡Unit Sales, the expected number of unit sales per year

US=ADD·356+(UL_{current}−UL)

where UL is the units lost per year calculated for the number of facings specific to the point in the process where the calculation is performed

and UL_{current} is the units lost per year calculated for the user entered Current Number of Facing

When Unit Sales is calculated for the Current Number of Facings, the equation reduces to

US=ADD·356

M≡Margin, based on the Cost of Lost Sales method chosen by the user

If the Contribution Margin method is chosen

M=P−C−ACD (Contribution Margin)

For all other methods

M=P−C (Gross Margin)

TC≡Total Cost

TC=IHC+LSC

Space≡Linear shelf space required for the given number of facings (in inches)

Space=F·w

Once the unconstrained optimization process is complete, the results appear in a table in the lower portion of the Scenario GUI (FIG. 7). Multiple tables are available to enable the user to view many types of metrics and figures from the analysis. The user can view the various tables by selection using the ‘View’ drop-down list-box. The available tables and metrics will be discussed further later in the document.

### CONSTRAINED MODE

Unlike the Unconstrained Mode of optimization, the Constrained Mode of optimization takes into account the maximum shelf space allowed for the items and presents the solution that will fit the space. In many cases, the solution presented will be less optimal than the unconstrained analysis, but it will be the optimal solution for a given set of constraints. The set of constraints depends on the goals of the retailer or supplier, as well as physical space and business practices.

For the typical retailer or supplier, the category of items in the analysis will have an associated business objective: driving sales throughput or unit sales, creating revenue, creating profit, creating margin, or reducing cost. It is an object of the present invention to select the product assortment and number of facings that meets these business objectives by performing merchandise optimization for a space-constrained environment. The invention provides for this objective in the Constrained Mode of optimization. Depending upon the purpose of the category of products in the analysis, the user will pick the associated objective: Maximize Unit Sales, Maximize Sales Revenue, Maximize Economic Profit, Maximize Gross Margin, or Minimize Total Cost. A weighted combination of objectives may also be used.

To perform optimization in the constrained mode, create a scenario as discussed previously in this document. In the Scenario window, select ‘constrained’ from the Optimization Mode drop-down list-box. (A sample GUI from the present invention is provided for example in FIG. 9.) Once the constrained mode is selected the user selects an objective from the list: minimize total cost, maximize economic profit, maximize gross margin, maximize sales revenue, maximize unit sales, or custom. When ‘custom’ is selected boxes are provided for entering weights to create a weighted combination of objectives. The user must also define the space available. The user can select a pre-defined space from a drop-down list-box or create a new definition by clicking the ‘Modify’ button. This opens a GUI that allows the user to define a shelf space, one shelf at a time, by height, width, and depth. Shelves may have different dimensions. Shelves may be added to or removed from the definition with the click of a button. The definition is named by the user and saved for current and future use. The user may also enter parameters for other constraints discussed below. When all desired parameters have been entered, clicking the ‘Optimize’ button initiates the constrained optimization.

The constrained merchandise optimization allows the user to implement the following “global” constraints, applicable to all items in the analysis, whose parameters are entered in the upper portion of the Scenario GUI (FIG. 9):

Min Facings: Each item in the solution will have at least the specified number of facings.

Max Facings: Each item in the solution will have no more than the specified number facings.

Max Items: The solution will contain no more than the specified number of SKUs. (This constraint is helpful for SKU rationalization.)

Space: The solution will either 1) “Stay within” or 2) “Fill To” the selected shelf space, based on the selection in ‘Space Fill Type’. In the first case, the solution will not exceed the shelf space indicated, but may not fill it. In the second case, the solution will fill up the shelf space, even if a solution using less space better satisfies the objective.

Ignore Height Dimension: When selected, the space constraint is formulated based only the width of the facings. When not selected, the space constraints are formulated based on the height and width of the facings, so that an item will only be considered for shelf space that can accommodate its height.

Maximum Average Investment $: The average inventory investment for the solution must not exceed the specified amount.

The user may also choose to specify item-level constraints for the analysis. These constraints must be specified prior to the optimization, either when the data is collected for import or by selecting the ‘Optimizer Setup’ table in the ‘View’ drop-down list-box in the Scenario GUI (FIG. 9). The item-level constraints are:

Assortment Override: The item must be kept or deleted from the resulting set.

Fix Facings: If included in the solution, the item must be set to a specified number of facings.

Min DOS: If included in the solution, the item must be set to a number of facings that yields shelf quantities greater than or equal to the specified DOS.

Max DOS: If included in the solution, the item must be set to a number of facings that yields shelf quantities less than or equal to the specified DOS.

Case Pack or Inner Pack Quantity: If included in the solution, the item must be set to a number of facings that allows a minimum number of cases or inner packs of product to be placed on the shelf.

Min Service Level: If included in the solution, the item must be set to a number of facings that yields at least the specified level of service.

Equal Facings: All items given the same identifier must be set to equivalent numbers of facings.

The method used to calculate the optimal solution in the Constrained Mode is very different from that used in the Unconstrained Mode. This method employs complex zero-one Integer Linear Programming to determine the optimal constrained product set which satisfies the constraints (global and item-level) applied by the user. The solution is the best one that fits within the constraints of shelf space, maximum facings, and others specified by the user.

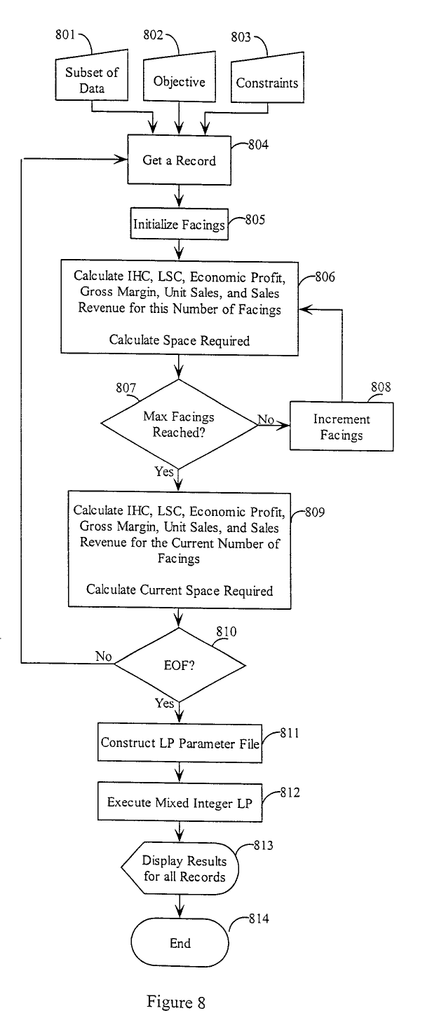

The process for merchandise optimization in the Constrained Mode is illustrated in the flow diagram in FIG. 8. The constrained optimization process begins with the input of a user-selected subset of data at step 801, a user selected objective function at step 802, and user selected constraints and constraint parameters at step 803. Then the process enters a loop to generate the coefficients for the integer linear program for each record in the data set. The loop begins by retrieving a record of data at step 804. Next, the number of facings is initialized to zero at step 805. Zero is used so that the optimization may choose to delete an item by giving it zero facings. The next step is to calculate Inventory Holding Cost (IHC), Lost Sales Cost (LSC), Economic Profit, Gross Margin, Unit Sales, Sales Revenue, and the shelf space required for the given number of facings at step 806. These calculations provide the coefficients for the objective function and the space constraints. The coefficients must be calculated for every possible number of facings for the item up to the user entered maximum number of facings, so the process next tests if the maximum number of facings has been reached at step 807. If the maximum number of facings has not been reached, the process enters a second loop where it increments the number of facings at step 808, calculates the coefficients for the new number of facings at step 806, and again tests if the maximum number of facings has been reached at step 807. When the maximum number of facings is reached, the process exits this second loop and calculates the IHC, LSC, Economic Profit, Gross Margin, Unit Sales, Sales Revenue, and the shelf space required for the user entered current number of facings at step 809, to allow for comparison of the current and optimal solutions. At this point, the processing of one record is complete. The process checks for the end of the file (EOF) at step 810. If there are still records in the file, the next record is retrieved at step 804 and the process repeats itself. All records in the data set are processed through this loop until the end of the file is reached.

When all records have been processed, the end of file test at step 810 gives a positive result. The next step is to use the data imported by the user, user entered parameters, and coefficients calculated previously in the process to construct the parameter file for the linear program at step 811. Once the parameter file has been constructed, the mixed integer linear program is executed at step 812 using any of a number of modeling and optimization software packages. The present invention uses a DASH product (XPRESSMP, Dash Associates Ltd.) or a CPLEX product (CPLEX Optimizer, ILog Corporation) to solve the mixed integer linear program. After the linear program is executed at step 812, the solution results are displayed for all records at step 813, and the process reaches a normal conclusion at step 814.

The key data for the constrained mode of optimization is the same as that needed for the unconstrained mode. The list is repeated here:

ADD≡Average Daily Demand

σ_{ADD}≡Standard Deviation of Demand

TBR≡Time Between Replenishment

LT≡Lead Time

σ_{LT}≡Standard Deviation of Lead Time

HCPF≡Holding Capacity per Facing

HCF≡Inventory Holding Cost Factor

C≡Cost retailer paid

P≡Price paid to retailer

w≡Width of a facing (in inches)

ACD≡Activity Cost Drivers, additional costs used in calculating the Contribution Margin (Distribution Center Inventory Cost, Distribution Center Labor Cost, Distribution Center Occupancy Cost, Store Inventory Cost, Store Labor Cost, Store Occupancy Cost, Transportation Cost)

Current Number of Facings

Many of the calculations for the coefficients generated in the constrained optimization process are the same as those discussed in the previous section. Calculations for Inventory Holding Cost, Lost Sales Cost, Economic Profit, Unit Sales, and space requirements in the constrained mode are the same as the respective calculations in the unconstrained mode and have already been introduced. The additional terms calculated during the constrained optimization process are shown below. As with the unconstrained calculations, these calculations are performed for a specific number of facings for a particular item.

GM≡Gross Margin of the item

GM=P−C

SR≡Sales Revenue of the item

SR=US·P

The current model formulation for optimization in the constrained mode is given below. This formulation builds on the terms already defined.

Definitions:

i≡index for the SKUs (or items)

N≡the total number of SKUs being optimized

j≡index for the number of SKU facings

M≡the maximum number of facings

k≡index for the shelf, sorted in decreasing height order

K≡total number of shelves (from the space definition)

s≡an intermediate number of shelves

l≡a pair of SKUs with the same Equal Facings identifier

I≡the maximum number of SKUs allowed in the solution

II≡the maximum allowable inventory investment

wᵢ≡the width of a single facing of SKU i

Wₖ≡the width of shelf k

xᵢⱼ≡the binary variable indicating the selection of j facings of SKU i

Objective Functions:

One function or a weighted combination of the functions is selected by the user for each instance of the model.

Minimize Total Cost

$$min {\sum }_{i = 1}^{N} {\sum }_{j = 0}^{M} {TC}_{ij} \cdot {x}_{ij}$$

Maximize Economic Profit

$$max {\sum }_{i = 1}^{N} {\sum }_{j = 0}^{M} {EP}_{ij} \cdot {x}_{ij}$$

Maximize Gross Margin

$$max {\sum }_{i = 1}^{N} {\sum }_{j = 0}^{M} {GM}_{i} \cdot {US}_{ij} \cdot {x}_{ij}$$

Maximize Sales Revenue

$$max {\sum }_{i = 1}^{N} {\sum }_{j = 0}^{M} {P}_{i} \cdot {US}_{ij} \cdot {x}_{ij}$$

Maximize Unit Sales

$$max {\sum }_{i = 1}^{N} {\sum }_{j = 0}^{M} {US}_{ij} \cdot {x}_{ij}$$

Constraints:

The following constraints are used in all instances of the model.

The decision variables are binary.

xᵢⱼ ε{0,1} ∀i,∀j

Only one number of facings may be chosen for each SKU.

$${\sum }_{j = 0}^{M} {x}_{ij} = 1 ∀ i$$

The solution must fit in the linear shelf space.

$${\sum }_{i = 1}^{N} {\sum }_{j = 0}^{M} j \cdot {w}_{i} \cdot {x}_{ij} \leq {\sum }_{k = 1}^{K} {W}_{k}$$

The following constraints are optional.

The solution must fill the shelf space. (global ‘Fill to’ Space constraint)

$${\sum }_{i = 1}^{N} {\sum }_{j = 0}^{M} j \cdot {w}_{i} \cdot {x}_{ij} \geq {\sum }_{k = 1}^{K} {W}_{k} - arg {max}_{i } ( {w}_{i} )$$

The number of SKUs selected must not exceed a specified limit. (global ‘Max Items’ constraint)

$${\sum }_{i = 1}^{N} {\sum }_{j = 0}^{M} {x}_{ij} \leq I$$

The height of an item must be considered in determining linear shelf space available to it. (global ‘Ignore Height’ constraint not selected)

$${\sum }_{i ∉ \{ SKUs fitting on smaller shelf s + 1 \}} {\sum }_{j = 1}^{M} j \cdot {w}_{i} \cdot {x}_{ij} \leq {\sum }_{k = 1}^{s} {W}_{k}$$

$$∀ s ∈ \{ 1 , … , K - 1 \}$$

where shelves, k, are sorted in decreasing height order

The solution must not exceed the allowable inventory investment (global ‘Max Avg Inv. $ constraint)

$${\sum }_{i = 1}^{N} {\sum }_{j = 0}^{M} {AIL}_{ij} \cdot {C}_{i} \leq II$$

The same number of facings must be selected for all SKUs given the same Equal Facings identifier by the user. (item level ‘Equal Facing’ constraint)

$${\sum }_{j = 0}^{M} j \cdot {x}_{{i}_{a} j} - {\sum }_{j = 0}^{M} j \cdot {x}_{{i}_{b} j} = 0$$

$$∀ l ∈ \{ ( {i}_{a} , {i}_{b} ) , ( {i}_{c} , {i}_{d} ) , … \}$$

where each pair of SKUs has the same Equal Facings identifier

The remaining global and item level constraints are implemented by fixing the necessary binary variables to zero or one. The constraints implemented in this way are, from the lists given earlier in the section, the item level constraints Assortment Override, Fix Facings, Min DOS, Max DOS, Case Pack and Inner Pack Quantity, Min Service Level, and the global constraint Min Facings.

Once the constrained optimization process is complete, the results appear in a table in the lower portion of the Scenario screen (FIG. 9). Multiple tables are available to enable the user to view many types of metrics and figures from the analysis. The user can view the various tables by selection using the ‘View’ drop-down list-box. The available tables and metrics will be discussed further in the next section.

### METRICS

When the optimization completes, the user tailors the display to show only the columns related to specific groupings of metrics, making the results easier to view. Each result table that the user may view contains columns describing the item, columns with current and optimal numbers of facings, and other metrics columns. To display only columns related to costs, select Holding/Lost Sales Cost from the drop-down list-box. (An example of the Holding/Lost Sales Cost table is shown in the lower portion of the GUI in FIG. 7.) To select only columns related to Economic Profit, select Economic Profit. (An example of the Economic Profit table is shown in the lower portion of the GUI in FIG. 9.) To display only columns related to shelf space, select Shelf Space. Other metrics are displayed in tables labeled Inventory Level, Service Level, Gross Margin, and Productivity. The user may also choose to export the results to a spreadsheet for further analysis.

Comparisons between the current and optimal solutions are easy to note by focusing on the colors of the columns. The columns containing current solution data have red text, and the columns containing optimal solution data have green text. At the bottom of the screen, totals are presented for each column. Multiple scenarios can be viewed jointly, for ease of comparison, by highlighting all desired scenarios in the initial Scenario interface. When the user views the scenarios, the data fields for each scenario appear side by side with the background color of the field differing for each scenario in correspondence with a legend that appears at the top of the screen.

Along with the imported data and many intermediate calculations, the metrics below are available for each item in the analysis. The formulas use definitions given previously in the document. In the present invention, all metrics are annualized.

The following metrics are calculated for each item.

Gross Margin (GM): P−C

Contribution Margin, the gross margin of the item less activity costs allocated to the item:

GM−ACD

Gross Margin Percentage (GM %), the gross margin as a percentage of cost: (GM/C)·100

The remaining metrics are calculated for both the current and the optimal number of facings of each item. A number of these metrics have already been defined. The previously defined metrics are Average Inventory Level, Economic Profit, Inventory Holding Cost, Lost Sales Cost, Sales Revenue, Space Required, Total Cost, Unit Sales, and Units Lost.

Additional metrics are:

Days of Supply, the average number of days of supply on the shelf: (F·HCPF)/ADD

Service Level, the percentage of demand fulfilled: (1−(UL/US))·100

Generally, service level is thought of as the probability of being in stock during a replenishment cycle and is computed by calculating a z value and looking up the percentage from the normal distribution. However, for the present invention, the formula given above is considered more appropriate because it takes the magnitude of a stockout into account.

Unit Turns, the average number of times inventory turns in a year, measured in units: US/AIL

Dollar Turns, the average number of inventory turns in a year, measured in dollars:

(US·C)/(AIL·C)

Gross Margin Dollars (GM$): GM·US

Gross Margin Return on Investment: GM$/AIL

Contribution to Margin, the ratio of an item's Gross Margin Percentage to its sales percentage:

GM %/((SR/ΣSR)·100)

Category Gross Margin Dollars Percentage, the percentage of the category's total Gross Margin generated by the item: (GM/ΣGM)·100

Gross Margin Dollars Per Inch: GM$/Space

Gross Margin Dollars Per Average Inventory Investment Dollar: GM$/(AIL·C)

Sales Revenue Per Inch: SR/Space

Sales Revenue Per Average Inventory Investment Dollar: SR/(AIL·C)

### USE OF RESULTS

After viewing the results of the optimization, a user has many options. The user may save the scenario for later reference. The user may create new scenarios to test different parameters, constraints, data, or objective functions. The user may also initiate a collaboration with others inside or outside their company. Collaboration will be discussed in the next section. Ultimately, when a workable solution is reached, the product assortment and number of facings given in the results are used by the retailer to set the product assortment and shelf layouts for their daily operation.

### COLLABORATION

A key innovation in the present invention is the ability to perform merchandise optimization in collaboration with other affected parties. Within the retail establishment, shelf layout decisions impact and are impacted by store operations, space planning, buying, and store replenishment. Shelf layout is also interrelated with the supplier functions of packaging, marketing, sales, category management, and research and development. The collaborative portion of the present invention enables these distinct, and often independent, business functions to interact on the shelf layout decisions that affect them.

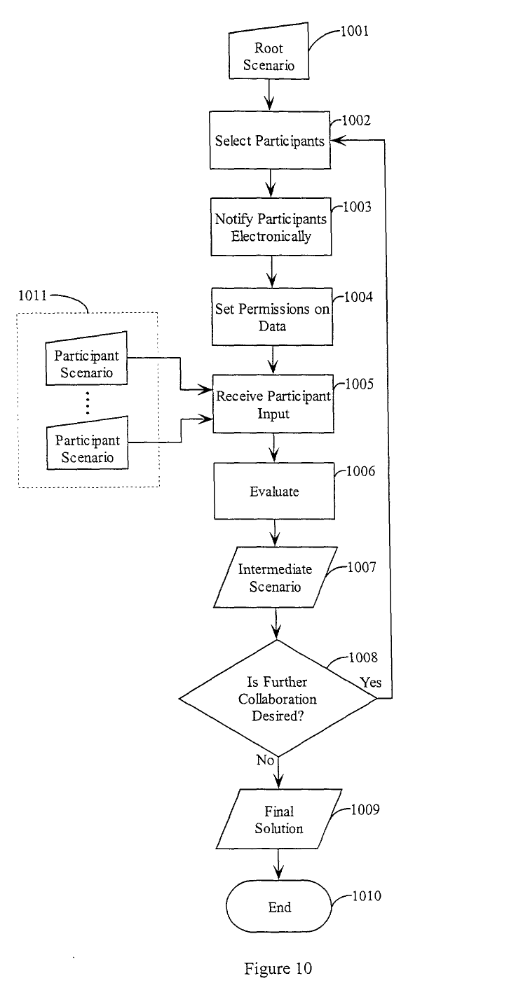

The foundation for collaboration is the user's root scenario. This scenario should be what the user feels is the optimal workable solution. Once a scenario is created, the user can initiate the collaboration process through a menu selection from the main toolbar. The collaboration process of the present invention is illustrated in the flow diagram shown in FIG. 10. The root scenario 1001 is the initial input into the collaboration process. Next, the user must select the participants for the collaboration at step 1002. In the present invention, this selection is made from an email address book created by the user by importing address information contained in the user's email application (such as Outlook Express or the like). The participants are then notified of the collaboration electronically and invited to participate at step 1003. Next the user must set permissions on the data in the scenario at step 1004. This enables the user to protect sensitive data by, for example, granting a supplier access to his data only, thus preventing him from seeing any data on a competitor's products.

Once the data is permissioned, the participants can view their data in the root scenario as well as the results. Then the participants copy the root scenario and create their own alternate scenarios at step 1011. In the alternate scenario, a participant may adjust their data, change constraints or objective functions, add or delete items, or take any other action discussed in the document, to create what they consider the best workable solution. Though a participant only has access to a portion of the data, when he reoptimizes, all data is included in the analysis. The scenarios created by the participants at step 1011 are returned to the user at step 1005. Once the user receives the alternate scenario input from the participants at step 1005, the user evaluates the participants' scenarios at step 1006. In the evaluation at step 1006, the user considers the objectives and limitations expressed in the participants' scenarios, in conjunction with the root scenario, and creates a new, intermediate scenario at step 1007. For the next step in the collaboration process, the user must decide whether further collaboration is desired 1008. If the user desires further input from the initial or new collaborators, the intermediate scenario becomes the root scenario and the process begins again with the selection of participants at step 1002. If the user is does not wish to carry out further collaboration, then a final solution has been reached at step 1009 and the process reaches a normal conclusion at step 1010.

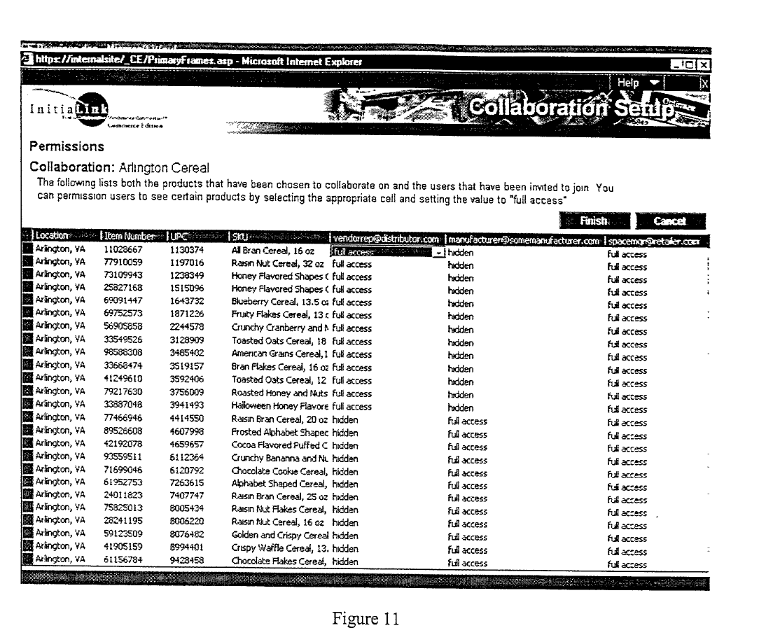

FIG. 11 is GUI from the present invention that enables the user to permission the data during the collaboration process. A record is displayed for each item in the scenario. The record consists of several columns identifying the item (item number, SKU, location, etc.) and a column for each of the participants where the data access level is indicated. For each item, in each participant column, the user must either allow or deny access to the data by selecting either ‘full access’ or ‘hidden’, respectively. The user may set the data permission values individually or select multiple cells and set the value for the group. If data is hidden from a participant, the entire record is grayed out when that participant views the scenario. Allowing users to limit the data access available to collaborative partners enables participants, while viewing and manipulating only their data, to create new scenarios based on all data used by the initial user.

### ADDITIONAL USES

While the most immediate use of the present invention is collaborative optimization of product assortment and facings for fixed retail space, there are additional applications of the process that enable further optimization of inventory and merchandising space. In an exemplary embodiment, the process can be used to analyze variable space that is replenished, like promotional displays and season-related variable space. For example, if a season-related variable space is replenished over a two month period, then, using historical demand and a forecast of future demand, average daily demand can be calculated. The rest of the variables are included as if fixed space were being optimized. All of the metrics in the fixed space analysis are annualized; therefore, the user would need to consider the metrics proportionally, in accord with the length of the replenishment season.

The first step is to define the season for the collection of SKUs that will be sold through replenished variable space. This definition must include the time period to be analyzed. Next the average daily demand data is determined using historical data or a demand planning system. Then, once data is imported and parameters set, the optimization engine is run. The unconstrained optimization mode can be used to determine how much space is required. If the amount of variable space is already specified, then the constrained optimization mode can be used to determine the optimal use of the space.

In another exemplary embodiment, the process can be used to analyze the impact of using case packs or inner packs. To do this type of analysis, two scenarios must be created. One scenario is a constrained optimization with the Case Pack or Inner Pack Quantity constraints turned off for the items being analyzed. The second scenario is a constrained optimization using the same data, objective, and constraints with the Case Pack or Inner Pack Quantity turned on for the items being analyzed and the Minimum Case Pack Quantity or Minimum Inner Pack Quantity parameters set. When the results of the two scenarios are viewed and metrics like Economic Profit, Gross Margin, and Sales per Inch are compared, the impact of the case packs or inner packs can be determined.

In an additional exemplary embodiment, the process can be used to analyze the economic impact of introducing a new item. First the user must create a baseline scenario by running a constrained optimization on the current products. Next, the user performs a New Item Analysis. The present invention contains a GUI that allows the user to enter data for the new item including cost, price, the number of facings desired, average daily demand, and lead-time. Then the items are reoptimized including the new item and economic profit metrics are calculated. These metrics include economic profit before the addition of the new item, economic profit with the new item, the change in economic profit, and the economic profit of the item. Through these metrics, the user can easily see the economic impact of the new item introduction.

In yet another exemplary embodiment, the process can be used to create a baseline for new item slotting fees. When a New Item Analysis is performed, as discussed above, the change in economic profit that a new item would cause is calculated. If the category is less profitable with the addition of the item, the only way for the retailer to avoid a loss is to make up the difference with the slotting fee paid by the manufacturer of the new item. So, the change in economic profit is the baseline for the slotting fee. If the category is more profitable with the addition of the new item, the retailer has more flexibility with the slotting fee. With this type of analysis, a retailer can determine the slotting fee necessary to break even on a new item.

The described invention offers many advantages. It provides merchandise optimization to determine optimal assortment and facings at the shelf level. It can be used in the unconstrained mode to determine benchmarks and in the constrained mode to determine the best use of available space. It takes into account the tradeoffs between the cost of holding inventory and the cost of a stockout. It optimizes over a variety of objectives and constraints, allowing the user to tailor the invention to his business objectives and limitations. And it enables true collaboration between multiple parties involved in and impacted by product assortment and layout of merchandising space.

### DEMAND REDISTRIBUTION

At the outset it is important to note that the subject invention may be practiced in a user service configuration, a main frame terminal configuration, or a personal computer network configuration including, client/server configurations including but not limited to client/server configurations communicably linked via wide area networks, local area networks, campus area networks, or any combination thereof. All such configurations are well known by those skilled in the art.

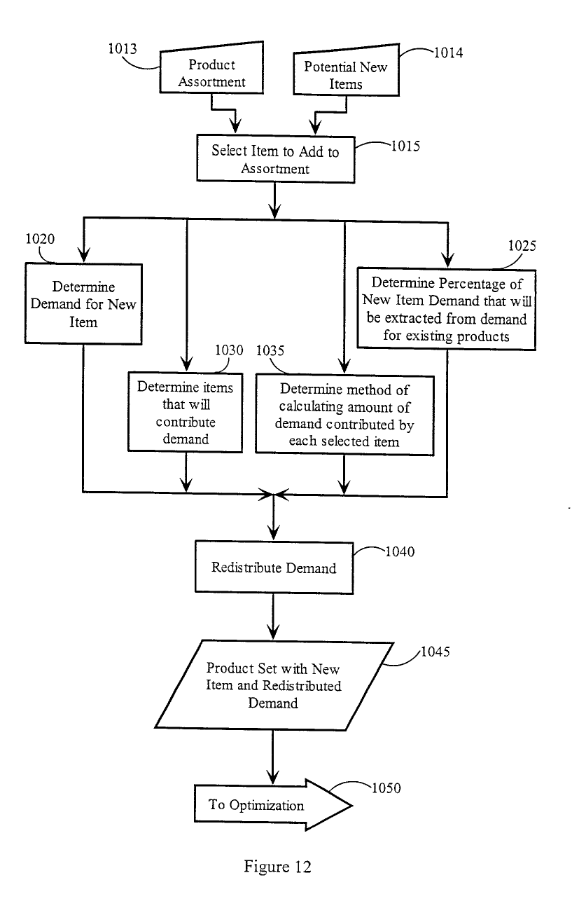

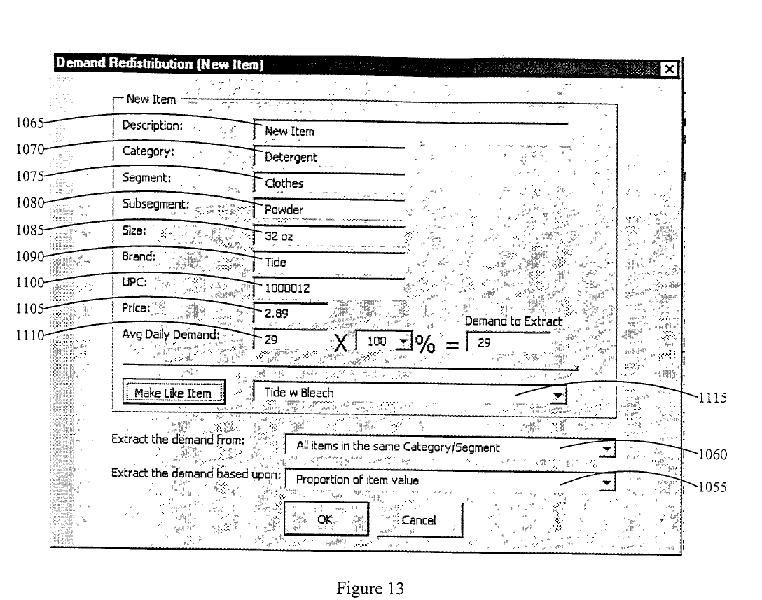

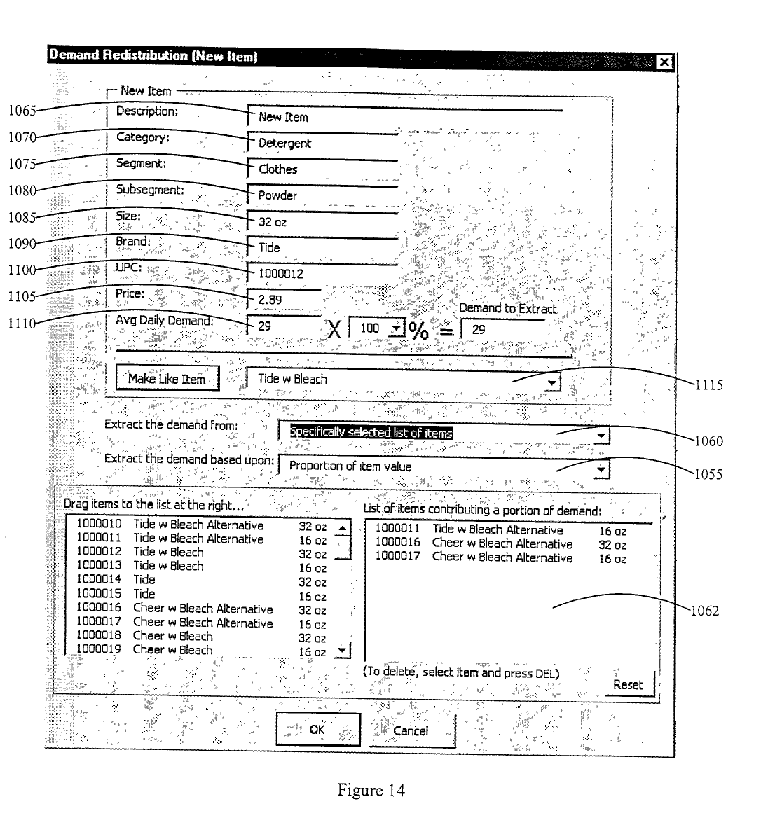

FIG. 12 is a flow chart illustrating the logic sequence of the invention's preferred embodiment for redistributing demand whenever a target product is added to an assortment of products. As referenced in FIG. 12, the target product or products is labeled potential new items 1014 while the product or assortment of products is labeled product assortment 1013. The first step in the practice of the invention's preferred embodiment for redistributing demand whenever a new target product is added to an assortment of products, is to select the item or target product to be added to the product assortment 1015. When practicing the invention's preferred embodiment, such selection and specification is facilitated via a graphical user interface (GUI), such as that which will be discussed in association with FIGS. 13 and 14. It is readily apparent to those skilled in the art, however, that such practice could be effectuated in the absence of a GUI.

Having once selected the target product to add to the product assortment 1015, the user makes four determinations regarding the redistribution of demand 1020-1035. These steps are independent of each other, so they can occur in any sequence. As one of these parallel steps the user determines an initial demand for the new item 1020. This initial demand 1020 must be estimated, and the user typically has some expectation of the anticipated demand through market research, supplier information, experience, or other information sets. A new target item will rarely attract all of its demand from the existing demand associated with other products. Often, at least, a portion of the demand for a new item will be newly created. This is typically the case encountered in which retailers want to generate new demand for products and not simply shift demand among existing products. Consequently, the user must also determine how much of the demand for the new item will be shifted from existing demand associated with focus products versus how much of the demand will be new demand. Such determination is typically without limitation, made through use of market intelligence, knowledge of the product category and experience. In association with FIG. 12, the user inputs this determined percentage of new item demand 1025. In the third of the parallel steps, the user is required to determine and specify the focus products that will contribute demand 1030, as all items in the target product's category will not necessarily contribute demand to the new target product. Based on knowledge and nature of the category, the user then selects items that are anticipated to relinquish some demand to the new item. The invention provides several ways the user can specify the focus items contributing demand to the target product and includes, but is not limited to, (a) all items in the same brand/subsegment/segment/category; (b) all items in the same subsegment/segment/category; (c) all items in the same segment/category; (d) all items in the category; or (e) a user selected subset of items from amongst the product set. For the fourth determination relating to the invention's preferred embodiment for redistributing demand whenever a target product is added to an assortment of products, the user is required to determine and specify a method of calculating the amount of demand attributed by each selected item 1035. In so doing, the user chooses the method of demand redistribution that is most appropriate for the category anticipated in response to the introduction of the new target product.

In choosing the method of demand redistribution, the user specifies the method by which the fraction of target product's demand contributed by each focus item is calculated. For purposes of illustration and disclosure the invention provides for seven such non-limiting methods for calculating said demand contribution and includes selection from a list comprised of:

(a) Inverse proportion of the focus item's price to the maximum price of the other focus items. This specification is typically used when the new item is anticipated to induce buyers to switch to a higher price product. Utilizing this method, items with lower prices contribute a higher proportion of the target item's demand than higher priced items.

(b) Proportion of a focus item's demand to the total demand of the focus items. This specification is typically used in general cases. Using this specification, items with higher demand attribute a higher quantity of demand to the new target item and those with lower demand contribute a lower quantity of demand. However, all items' contributions represent equivalent proportions of their own demand when utilizing this specification.

(c) Proportion of a focus item's value to the total value of the focus items. This specification is typically employed whenever the new item is considered to be of high value in a category where value is a key selling point. Utilizing this specification, items with a higher value measure contribute a higher proportion of the target item's demand than those with items of lower measure.

(d) Proportion of a focus item's revenue contribution to the total revenue contribution of the focus items. This specification is typically used when those focus items with more significant contributions to revenue are expected to contribute a higher quality of demand to the target item. Using this specification, items with higher revenue contribution will provide a higher proportion of the target item's demand than those items with lower revenue contribution.

(e) Equal proportions. This specification is typically used for general cases. Using this methodology, each focus item contributes the equivalent quantity of demand irrespective of any other factors.

(f) Similarity in price between the focus item and the target item. This specification is typically used in categories where consumers are price conscious and are therefore likely to purchase a new item with a price similar to the price they currently pay. Using this specification, focus items with prices similar to the target item's price contribute a higher proportion of the new item's demand than those items with prices with a larger difference (either positive or negative) from the target item's price.

(g) Similarity in value between the focus item and the target item. This specification is typically used in categories where consumers are value conscious and are therefore likely to purchase a new item with a value similar to the value of the item they currently buy. When using this specification, focus items with value similar to the target item's value contribute a higher proportion of the target item's demand than those items with values with a larger difference (either positive or negative) from the target item's value.

Having once specified the demand for the new item, the percentage of demand contributed by existing items, the items that will contribute demand, and the methodology or model for calculating the amount of demand contributed by each selected item, the user instructs the invention to redistribute demand 1040. In so doing, the invention based upon the afore noted pre-specified user criteria, determines the quantity of demand to be distributed from all the contributing focus items to the new target item and adjusts the demand accordingly for all affected focus items, resulting with a product assortment containing a new target item with demand redistributed according to the user's specified criteria 1045. It should be noted that demand for the new product set has not decreased, it has been shifted. Though demand may have increased if the introduction of the new item is expected to created demand. This new product assortment is ready for optimization as indicated in the present invention's parent application, which will determine the impact of the addition of the new item. The invention further allows for additional changes to the new product assortment prior to such optimization 1050. FIGS. 13 and 14 illustrate non-limiting representative graphical interfaces with varying degrees of detail for executing the invention's demand redistribution sequence whenever a target product has been added to an assortment of products. As can be readily appreciated from FIGS. 13 and 14, representative graphical user interfaces may be employed to communicate to the invention input criteria necessary to effectuate a demand redistribution whenever a new target product is added to a product assortment. By way of illustration, such user interfaces without limitation would include input fields to determine the model or methodology of calculating the amount of demand contributed by each selected item 1055, focus items that are expected to contribute demand to the newly added target product 1060, including fields to specify a user selected list 1062, new item specification criteria including without limitation new item description 1065, category 1070, segment 1075, subsegment 1080, size 1085, brand 1090, UPC code 1100, price 1105, average daily demand 1110. Much of the new item data can be initially populated by selecting an existing item similar to it 1115. It should be noted that the data entered in the interface discussed above, can also be imported into the system as part of a data file.

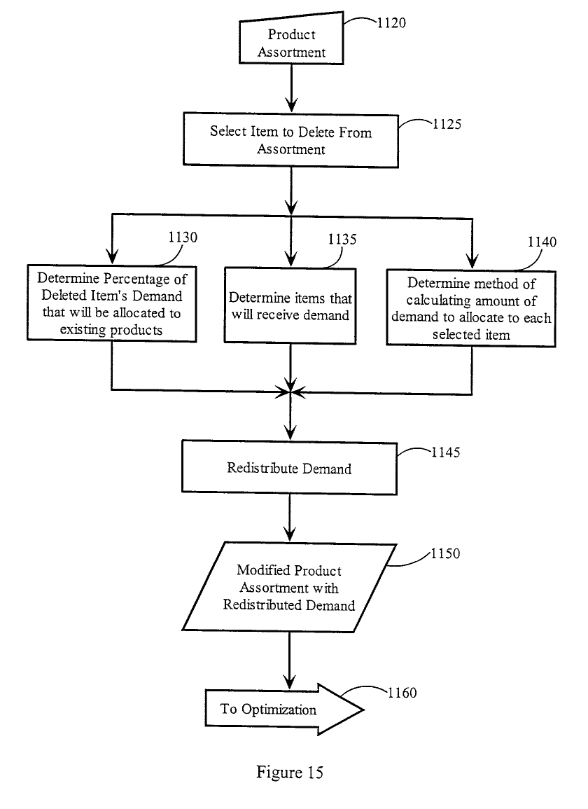

FIG. 15 is a flow chart depicting the logic sequence of the invention's preferred embodiment for redistributing demand whenever a target product is deleted from an assortment of products. As can be seen in FIG. 15, an existing product assortment 1120 is to have its demand redistributed as a consequence of a target product deletion from the product assortment set. To determine such a redistributed demand a user first selects the target item or items to delete from the product assortment 1125. Having once selected the desired product or products 1125, the user makes three determinations, in any sequence 1130-1140. As one of these determinations, the user specifies the percentage of demand for the deleted item that will be allocated to remaining products 1130. Such a determination, without limitation, is made through the use of marketing intelligence, knowledge of the category and experience. In practicing the invention in its preferred embodiment, the user specifies the focus items that will receive demand as a consequence of the target products deletion 1135. Based on knowledge of the nature of the category, the user selects focus items that are anticipated to gain some demand from the deleted target item 1135. The more focus items selected the broader the impact of the target item deletion. The invention offers a number of ways the user can specify the group of focus items and without limitation would include:

a. All items in the same Brand/Subsegment/Segment/Category

b. All items in the same Subsegment/Segment/Category

c. All items in the same Segment/Category

d. All items in the Category

e. User selected subset of items from the product assortment.

f. Subset of items selected based on Consumer Switching behavior. This method is used to take advantage of market research or other more specific data that shows how consumers react to stockouts of a product. A product deletion is a permanent stockout. Consumers react in many ways to stockouts, but there are three reactions that result in demand being shifted to another product—switching brand, switching product, and switching size. If the planner has entered Consumer Switching behavior for the item being deleted, the percentages for these three behaviors are normalized and the system determines which items fall into each switching category. (The planner can override these determinations.) Using this method more accurately reflects how demand will be redistributed.

In addition to determining and specifying the focus items that will receive demand as a consequence of the target products deletion, the user must determine and specify the model by which the amount of demand allocated to each focus item will be calculated 1140. Without limitation such models as practiced in the invention's preferred embodiment include:

(a) Inverse proportion of the focus item's price to the maximum price of other selected items—for use when it is anticipated that consumers will switch to lower priced alternatives. In this method, items with lower prices are allocated a higher proportion of the target item's demand than higher priced items.

(b) Proportion of the focus item's demand to the total demand of the focus items—for use in general cases. This is one of the methods commonly used in demand redistribution. In this method, items with higher demand receive a higher quantity of demand from the deleted target item and those with lower demand receive a lower quantity of demand, but all items' allocations represent equivalent proportions of their own demand.

(c) Proportion of the focus item's value to the total value of the focus items—for use when the deleted item is considered to be of high value (by some measure of value—we propose one measure) in a category where value is a key selling point. In this method, items with a higher value measure receive a higher proportion of the deleted target item's demand than those items with a lower value measure.

(d) Proportion of the focus item's revenue contribution to the total revenue contribution of the focus items—for use when items with high revenue contribution are expected to be significant substitutes. In this method, items with higher revenue contribution receive a higher portion of the deleted target item's demand than those items with lower revenue contributions.

(e) Equal proportions—for use in general cases. This is another commonly used redistribution method. In this method, each focus item is allocated the equivalent quantity of demand, regardless of any other factors.

(f) Similarity in price between the focus item and the target item—for use in categories where consumers are price conscious and are therefore likely to purchase a substitute item with a price similar to that of the deleted item. In this method, focus items with prices similar to the target item's price receive a higher proportion of the deleted target item's demand than those items with prices with a larger difference (either positive or negative) from the deleted item's price.

(g) Similarity in value between the focus item and the target item—for use in categories where consumers are value conscious and are therefore likely to purchase a substitute item with a value similar to that of the target item. In this method, focus items with value similar to the target item's value receive a higher proportion of the deleted target item's demand than those items with values with a larger difference (either positive or negative) from the deleted item's value.

Having determined and specified the afore noted user criteria, the user instructs the invention to redistribute demand based upon said input criteria 1145 wherein the quantities of demand to be redistributed from the deleted target item will be reallocated to the receiving focus items with demand adjusted accordingly for all affected items 1145. The results from the invention's redistributed demand processing in accordance with the afore noted user criteria is a product assortment with one or more items removed with demand redistributed according to the user specification 1150. It should be noted that the demand in the revised product set has not been increased but has been shifted. Though demand may have decreased if some of the demand for the deleted target item is not expected to be fulfilled by a substitute. The revised product assortment is now ready for optimization as noted in the instant parent application to determine the impact of the deletion of the item. The user at this point may, prior to the optimization, make additional changes to the product assortment 1160.

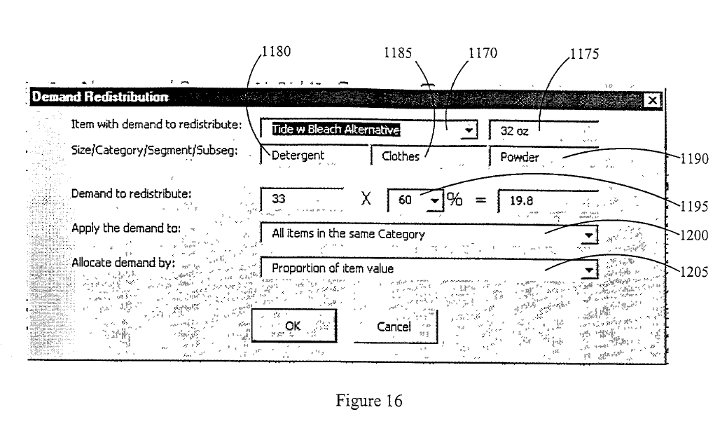

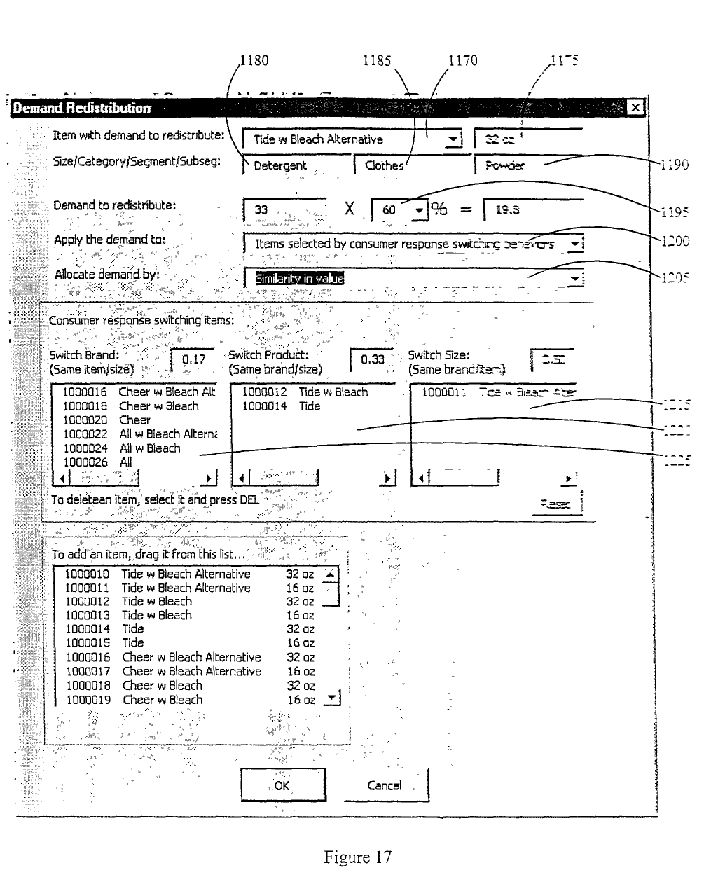

FIGS. 16 and 17 illustrate non-limiting representative graphical user interfaces with varying degrees of detail to facilitate a demand redistribution when deleting a target product from an existing product assortment. Non-limiting fields to allow the specification and communication of user input criteria in FIGS. 16 and 17 include, but are not limited to, the item with demand to redistribute, i.e. item to be deleted, 1170, item size 1175, item category/segment/subsegment 1180, 1185, 1190 respectively, a percentage of demand to redistribute 1195, items to which the redistributed demand is to be applied to 1200, an allocation model by which said redistribution demand is to be factored 1205 and lists of focus items to receive a portion of the demand resulting from said target items deletion 1215, 1220, 1225. These lists are based on consumers' tendency to switch brand 1215, product 1220, or size 1225 when their desired product is not available. These lists are generated by the system but can be adjusted by the user. (A field allowing user specification of a general list, such as that shown in FIG. 14, 1062, may also be included.) It should be noted that the data entered in the interface discussed above can also be imported into the system as part of a data file.

To assist in the comprehension of the invention and to further facilitate full and descriptive disclosure, the following discussion provides an overview of the invention's demand redistribution processing relating to target product deletion and addition as presented within an algorithmic context.

Demand Redistribution For New Item:

Problem Context:

The current solution disclosed in the parent application assumes that demand for a target product item being considered for adding in to a product assortment is completely new demand and that there is no impact on the demand of other items in the mix by adding in the new item. The current solution should take into account that new target items will impact the existing focus items' demand and that consumers who were purchasing other items in the mix will shift to the new item, thereby lowering the demand on these items in the mix.

Invention Solution Methodology:

The ideal solution will provide a means for a user to reallocate demand for an item from some existing item or items in the assortment. The user should be able to specify a reasonable demand amount for the new item, the method to use for allocating demand, and the items, which are to contribute to the reallotment of demand. The solution will show both direct (demand allocated to an item before redistribution) and indirect (incremental demand due an item introduction) demand. It will provide a clean interface for the user with as few prompts as possible. It will take into account existing fields in the database and create few if any new fields.

Utilization Position:

Retailers and suppliers will both use this feature. It will be used to justify inventory levels for items that are being considered for adding to the assortment.

Methodology Description:

First, the user will be asked to fill in information about a new item (Brand, SKU, Category, Segment, etc.) being considered for addition, including the total demand that will be expected for the item.

Then, the user is asked to indicate the percentage of the average daily demand for the item that should be extracted from the current items (or subset of items) in the category. This percentage will range to 100%.

Then, the user is asked to select the items to contribute an allotment of this redistributable demand. There will be five possible methods for selecting items: 1) items within the same category as the source item, 2) items within the same category/segment, 2) items within the same category/segment/subsegment, 4) items within the same category/segment/subsegment/brand, and 5) a list of items selected by the user.

Finally, the user is asked to indicate the method to use to allocate demand. Seven methods are available: Redistribute demand based upon 1) the inverse proportion of the contributing item's price compared to other items in the selected group, 2) the proportion of the contributing item's demand, 3) the proportion of the item's value, 4) proportion of the item's revenue contribution, 5) equal proportions, 6) based on item price similarity to the source item, and 7) based on item value similarity to the source item. Options 1-4 above assume that the larger an item's proportion (or inverse proportion), relative to other items in the assortment, the higher should be that item's allotment. Options 6 & 7 assume that items closer to the new item's price or value should receive a larger allotment

Features

A wizard to guide the user through selecting items, selecting contributing items, and indicating the method for allotment

Calculation of an item's “value” since price and demand alone are generally not sufficient predictors of selecting alternatives within a category

Ability to quickly select a range of items or individual items.

Ability to specify a specific group of items

Allotting demand by proportion of item price, value, demand, and revenue contribution

Allotting demand by equal proportions to selected items.

Allotting demand by price or value similarity

Showing original, incremental, and adjusted demand for all items

Formulations used in the calculation of redistribution of demand:

Item Value

Valueᵢ=ln(1+(ln(exp(1)+ADDᵢ)^{Price}i))

Value is a subjective measure of the value or worth of a product. It takes into account the worth of the product by the consumer by factoring in the average demand for the product. It also factors in the worth of the product from the manufacturer's perspective by incorporating the price of the product. Obviously, the manufacturer's price has a larger influence on the calculation than the average demand (ADD). Overall, when using this value compared to other items in the mix, the value represents the overall worth or quality of a product. It is used to redistribute demand by proportion of item value and by the similarity of item value.

Scaled Item Value

ScaledValueᵢ=((Valueᵢ−min(Valueᵢ))/(max(Valueᵢ)−min(Valueᵢ)))*(100-1)+1

This metric is the item Value scaled to a number between 1 to 100. It should be used if to display the value to the user instead of the raw Value number since it can be interpreted more easily. An item that is valued extremely highly will have a Scaled Value of 100 while a product with a low value will have a Scaled Value of 1. This measure, of course, is relative to all other items in the assortment.

Demand based on Average Daily Demand (ADD) Proportion

Dᵢ=ADDᵢ/sum(ADDᵢ) * (ADDⱼ * Pctⱼ)

This metric is used to determine the units of demand that will be extracted from an item (i) because of the addition of an item (j). It is the proportion of the contributing item's ADD to the total ADD for all items times the units that will be switched to the new item. The Pct term represents the total percentage of units of demand that will be switched when the item is added.

Demand based on Value Proportion

Dᵢ=Valueᵢ/sum(Valueᵢ) * (ADDⱼ * Pctⱼ)

This metric is used to determine the units of demand that will be extracted from an item (i) because of the addition of a new item (j). It is the proportion of the contributing item's Value to the total Value for all items times the units that will be switched to the item that will be added. The Pct term represents the total percentage of units of demand that will be switched when the item is added.

Demand based on Revenue Contribution Proportions

RevContribᵢ=ADDᵢ * Priceᵢ

Dᵢ=(RevContribᵢ)/sum(RevContribᵢ) * (ADDⱼ * Pctⱼ)

This metric, Dᵢ, is used to determine the units of demand that will be extracted from an item (i) because of the addition of an item (j). It is the proportion of the contributing item's RevContrib to the total RevContrib for all items that are in the switching group times the units that will be switched to the new item. The Pct term represents the total percentage of units of demand that will be switched when the item is added.

Demand based on Equal Proportions

Dᵢ=(ADDⱼ * Pctⱼ)/count (itemᵢ)

This metric, Dᵢ, is used to determine the units of demand that will be extracted from an item (i) because of the addition of an item (j). It is the units that will be switched to the new item divided by the total number of items that are in the switching group. The Pct term represents the total percentage of units of demand that will be switched when the item is added.

Demand based on Inverse Price Proportion

InvPriceᵢ=max(Priceᵢ)/Priceᵢ

Dᵢ=InvPriceᵢ/sum(InvPriceᵢ) * (ADDⱼ * Pctⱼ)

This metric, Dᵢ, is used to determine the units of demand that will be extracted from an item (i) because of the addition of an item (j). It is the proportion of the contributing item's InvPrice to the total InvPrice for all items times the units that will be switched to the new item. The Pct term represents the total percentage of units of demand that will be switched to the new item when the item is added.

Demand based on Similarity in Price

PriceDiffᵢ=abs(Priceᵢ−Priceⱼ) * 100+1

SimPriceᵢ=max(PriceDiffᵢ)/PriceDiffᵢ

Dᵢ=SimPriceᵢ/sum(SimPriceᵢ) * (ADDⱼ * Pctⱼ)

This metric, Dᵢ, is used to determine the units of demand that will be extracted from an item (i) because of the addition of an item (j). It is the proportion of the contributing item's SimPrice to the total SimPrice for all items times the units that will be cannibalized to the new item. The Pct term represents the total percentage of units of demand that will be cannibalized when the new item is added.

Demand based on Similarity in Value

ValueDiffᵢ=abs(Valueᵢ−Valueⱼ) * 100+1

SimValueᵢ=max(ValueDiffᵢ)/ValueDiffᵢ

Dᵢ=SimValueᵢ/sum(SimValueᵢ) * (ADDⱼ * Pctⱼ)

This metric, Dᵢ, is used to determine the units of demand that will be extracted from an item (i) because of the addition of a new item (j). It is the proportion of the contributing item's SimValue to the total SimValue for all items in the switching group times the units that will be cannibalized to the new item. The Pct term represents the total percentage of units of demand that will be switched when the item is added.

Demand Redistribution For Deleted Item

Problem Context:

The current solution disclosed in the parent application assumes that demand for a target product being considered for deletion will drop to zero when the item becomes unavailable on the shelf. If demand for a product is obvious, then at least some of the demand will be applied to other focus products in the absence of the item in question. The current solution can be modified to account for potential switching behaviors.

Invention Solution Methodology:

The ideal solution will provide a means to reallocate demand for an item to some existing item or items in the assortment. The user should be able to specify demand amount (based on some percentage of current demand), the method to use for allocating demand, and the items which are to receive the reallotment of demand. The solution allows both direct (demand allocated to an item before redistribution) and indirect (incremental demand due an item deletion) and provides for a clean interface for the user with as few prompts as possible.

Utilization Position:

Retailers and suppliers will both use this feature. It will be used to justify inventory levels for items that are affected by demand redistribution. It will be used to plan for deletion of items from an assortment prior to making the assortment decision

Methodology Description:

First, the user will be asked to select an item. Any item from any category can be selected.

Then, the user is asked to indicate the percentage of the average daily demand for the item that should be allocated to the remaining items (or subset of items) in the category. This percentage will range to 100%.

Then, the user is asked to select the items to receive an allotment of this redistributable demand. There will be six possible methods for selecting items. 1) items within the same category as the source item, 2) items within the same category/segment, 3) items within the same category/segment/subsegment, 4) items within the same category/segment/subsegment/brand, 5) a list of items selected by the user, 6) items that would be selected if the consumer switches to another brand, product, or size.

Finally, the user is asked to indicate the method to use to allocate demand. Seven methods are available: Redistribute demand based upon 1) the inverse proportion of the receiving item's price compared to other items in the selected group, 2) the proportion of the item's demand, 3) the proportion of the item's value, 4) the proportion of the item's revenue contribution, 5) equal proportions, 6) based on item price similarity to the source item, and 7) based on item value similarity to the source item. Options 1-4 above assume that the higher an item's proportion (or inverse proportion), relative to other items in the assortment, the higher should be that item's allotment. Options 6 and 7 assume that items closer to the source item's price or value should receive a larger allotment.

The present invention when practiced in its preferred embodiment provides for:

A wizard to guide the user through selecting items, selecting receiving items, and indicating the method for allotment

Calculation of an item's “value” since price and demand alone are generally not sufficient predictors of selecting alternatives within a category

Ability to quickly select a range of items or individual items.

Ability to specify a specific group of items

Take into account consumer switching behaviors when items are out of stock. Use the switching percentages to indicate allotments for items that will be switched to given logical consumer switching behaviors.

Allotting demand by proportion of item price, value, demand, and revenue contribution.

Allotting demand by equal proportions to selected items.

Allotting demand by price or value similarity

Showing original, incremental, and adjusted demand for all items.

Formulations used in the calculation of redistribution of demand:

Item Value

Valueᵢ=ln(1+(ln(exp(1)+ADDᵢ)^{Price}^{ᵢ}))

Value is a subjective measure of the value or worth of a product. It takes into account the worth of the product by the consumer by factoring in the average demand for the product. It also factors in the worth of the product from the manufacturer's perspective by incorporating the price of the product. Obviously, the manufacturer's price has a larger influence on the calculation than the average demand (ADD). Overall, when using this value compared to other items in the mix, the value represents the overall worth or quality of a product. It is used to redistribute demand by proportion of item value and by the similarity of item value.

Scaled Item Value

ScaledValueᵢ=((Valueᵢ−min(Valueᵢ))/(max(Valueᵢ)−min(Valueᵢ)))*(100-1)+1

This metric is the item Value scaled to a number between 1 to 100. It should be used to display the value to the user instead of the raw Value number since it can be interpreted more easily. An item that is valued extremely highly will have a Scaled Value of 100 while a product with a low value will have a Scaled Value of 1. This measure, of course, is relative to all other items in the assortment.

Demand based on Average Daily Demand (ADD) Proportion

Dᵢ=ADDᵢ/sum(ADDᵢ) * (ADDⱼ * Pctⱼ)

This metric is used to determine the units of demand that will be added to an item (i) because of the delisting of an item (j). It is the proportion of the receiving item's ADD to the total ADD for all items that are in the switching group times the units that will be switched from the item that will be delisted. The Pct term represents the total percentage of units of demand that will be switched when the item is delisted.

Demand based on Value Proportion

Dᵢ=Valueᵢ/sum(Valueᵢ) * (ADDⱼ * Pctⱼ)

This metric is used to determine the units of demand that will be added to an item (i) because of the delisting of an item (j). It is the proportion of the receiving item's Value to the total Value for all items that are in the switching group times the units that will be switched from the item that will be delisted. The Pct term represents the total percentage of units of demand that will be switched when the item is delisted.

Demand based on Revenue Contribution Proportions

RevContribᵢ=ADDᵢ * Priceᵢ

Dᵢ=(RevContribᵢ)/sum(RevContribᵢ) * (ADDⱼ * Pctⱼ)

This metric, Dᵢ, is used to determine the units of demand that will be added to an item (i) because of the delisting of an item (j). It is the proportion of the receiving item's RevContrib to the total RevContrib for all items that are in the switching group times the units that will be switched from the item that will be delisted. The Pct term represents the total percentage of units of demand that will be switched when the item is delisted.

Demand based on Equal Proportions

Dᵢ=(ADDⱼ * Pctⱼ)/count(itemᵢ)

This metric is used to determine the units of demand that will be added to an item (i) because of the delisting of an item (j). It is the units that will be switched from the item that will be delisted divided by the total number of items that are in the switching group. The Pct term represents the total percentage of units of demand that will be switched when the item is delisted

Demand based on Inverse Price Proportion

InvPriceᵢ=max(Priceᵢ)/Priceᵢ

Dᵢ=InvPriceᵢ/sum(InvPriceᵢ) * (ADDⱼ * Pctⱼ)

This metric, Dᵢ, is used to determine the units of demand that will be added to an item (i) because of the delisting of an item (j). It is the proportion of the receiving item's InvPrice to the total InvPrice for all items that are in the switching group times the units that will be switched from the item that will be delisted. The Pct term represents the total percentage of units of demand that will be switched when the item is delisted.

The InvPrice is used because, when switching to an item because due to unavailability of another item, the consumer will typically switch to the lowest cost item alternative, rather than to items that cost more than the unavailable item.

Demand based on Similarity in Price

ValueDiffᵢ=abs(Valueⱼ−Valueⱼ) * 100+1

SimValueᵢ=max(ValueDiffᵢ)/ValueDiffᵢ

Dᵢ=SimValueᵢ/sum(SimValueᵢ) * (ADDⱼ * Pctⱼ)

This metric, Dᵢ, is used to determine the units of demand that will be added to an item (i) because of the delisting of an item (j). It is the proportion of the receiving item's SimPrice to the total SimPrice for all items in the switching group times the units that will be switched from the item that will be delisted. The Pct term represents the total percentage of units of demand that will be switched when the item is delisted.

Demand based on Similarity in Value

ValueDiffᵢ=abs(Valueᵢ−Valueⱼ) * 100+1

SimValueᵢ=max(ValueDiffᵢ)/ValueDiffᵢ

Dᵢ=SimValueᵢ/sum(SimValueⱼ) * (ADDⱼ * Pctⱼ)

This metric, Dᵢ, is used to determine the units of demand that will be added to an item (i) because of the delisting of an item (j). It is the proportion of the receiving item's SimValue to the total SimValue for all items in the switching group times the units that will be switched from the item that will be delisted. The Pct term represents the total percentage of units of demand that will be switched when the item is delisted.

Switching based upon Consumer Response

In the event the user desires to calculate demand redistribution based upon Consumer Response switching behaviors, the formulas above are modified slightly. The system first generates a list of items that will be switched to when switching to a different brand item. The formulas are applied to this list such that the sums and proportions are calculated within this subgroup. The program then generates a list of items that will be switched to when switching to a different product. These formulas are again applied to the list such that the sums and proportions are calculated within this subgroup. The same is done for items that are switched to when switching sizes. The proportions calculated for each subgroup are multiplied by the normalized percentage of consumers who will take the action represented by the subgroup such that the sum of these three subgroups represent the total units switched for all the items.

The present invention enables retailers and their suppliers to more accurately analyze product additions and deletions by determining and communicating the redistribution of product demand in each of these cases. The invention provides a wide selection of choices for determining focus products and for determining the method by which demand will be redistributed. The invention is not biased toward any particular methods, but provides many different methods so as to increase the ability of the user to accurately represent the scenario for analysis.

In yet another exemplary embodiment of the present invention, the invention is expanded so that the functionality of the invention and the breadth of the areas to which it can be applied are widened. In the prior discussion of the Constrained Optimization, the solution is primarily constrained by space and there are several other constraints with which the user may constrain the solution if they so desire. One of these optional constraints limits the solution based on the maximum average dollars invested in inventory. With this exemplary embodiment of the invention, the invention does not assume that the primary constraint is space. It allows the user to optimize using inventory investment or space as the primary constraint. The remainder of the optional constraints are still available but must be paired with at least one of the previously mentioned primary constraints.

This exemplary embodiment allows on-line retailers, who have greater concern for inventory investment and little or no concern for space, to harness the optimization power of the present invention. This enables on-line retailers to optimize assortment and order quantities based on the money available for inventory investment. The flexibility is also valuable to hybrid retail establishments that own both on-line retail sites and physical retail stores. They can optimize using the same tool for both types of sales channels.

The general operation of this exemplary embodiment is very similar to that of the other embodiments discussed previously. The additional functionality and flexibility of the current embodiment is created by defining additional data fields, enhancing the constrained optimization mode, and defining additional metrics. All other operations of the this embodiment of the invention, like importing data, viewing and editing data, creating subsets, calculating cost of lost sales, unconstrained optimization, and collaboration, are essentially the same. Further, this enhancement is independent of the demand redistrubtion functionality previously disclosed. This embodiment can include demand redistribution but such inclusion is not required.

In order to enable the expanded functionality and flexibility for this exemplary embodiment, several new data fields have been added to those in previous embodiments. Since this embodiment may be used by on-line retailers interested in inventory and order quantities, rather than facings and shelf layout, several data fields have been added to the embodiment. Many of these data fields are related to order lots. An order lot is the unit in which a product is ordered, like a pallet or case. This term is used to enable flexibility in the representation of product quantities. The additional data fields are:

Current Number of Order Lots

Number of Units per Order Lot

Width of an Order Lot

Height of an Order Lot

Depth of an Order Lot

Current Cube

Slot Number

Bay Number

Fixed Order Lot Quantity

Force a fixed number of Order Lots (Boolean)

Since the enhancement in this embodiment centers on the addition of a primary constraint, the Unconstrained Mode was not affected. However, several metrics have been added, and will be discussed in greater detail hereinafter, that enable a user concerned with inventory investment to obtain relevant information from an unconstrained optimization.

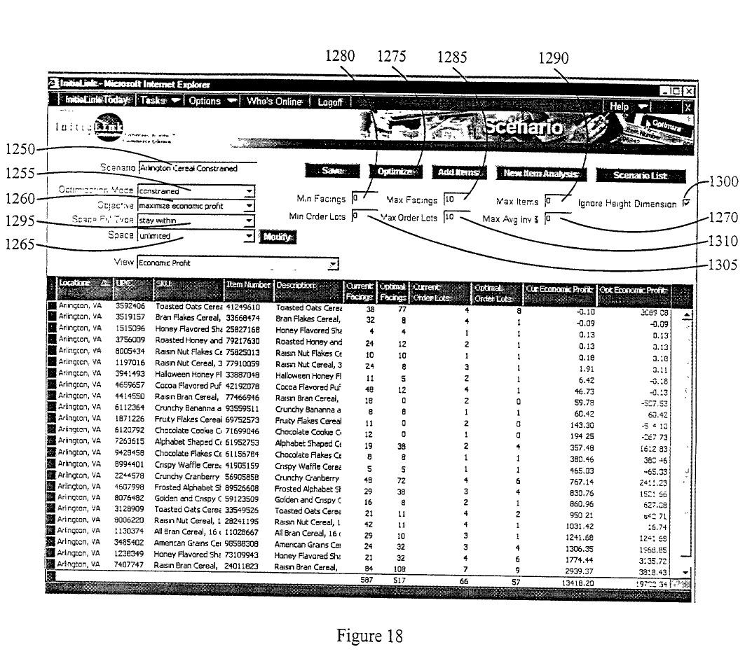

The constrained mode of optimization of the present embodiment has been expanded to allow for flexibility in the application of constraints. (A sample GUI from the present embodiment is shown in FIG. 18.) To perform merchandise optimization in the constrained mode, as in the previous embodiments, the user creates and names a scenario 1250, selects constrained as the Optimization Mode 1255, and selects an Objective 1260. The user may then define the space available or select “unlimited” from the drop-down list-box 1265. If “unlimited” space is selected, the user must enter the maximum average inventory investment dollar amount in the ‘Max Avg Inv $’ box 1270, making inventory investment the primary constraint on the solution. If no inventory investment amount is entered, space is the primary constraint. If both a space definition and a maximum average inventory investment are given, both constraints will be formulated and applied in generating the optimal solution. Once the user has entered parameters for the desired primary and optional constraints, clicking the ‘Optimize’ button 1275 initiates the constrained optimization.

In addition to Min Facings 1280, Max Facings 1285, Max Items 1290 and Space Fill Type 1295 and Height 1300 constraints, the present embodiment also allows the user to implement the following global constraints:

Min Order Lots 1305: Each item in the solution will have at least the specified number of order lots.

Max Order Lots 1310: Each item in the solution will have no more than the specified number of order lots.

The user may also use the previously disclosed item-level constraints—Assortment Override, Fix Facings, Min DOS, Max DOS, Case Pack or Inner Pack Quantity, Min Service Level, and Equal Facings—though some may not be relevant to particular situations. This embodiment has one additional item-level constraint:

Fix Order Lots: If included in the solution, the item must be set to the specified number of order lots.

The constrained optimization process is based on facings. If the user enters Current Order Lots or Max Order Lots, these figures are converted into facings prior to optimization using the following formula:

$$Facings = \frac{OrderLots \cdot UOL}{HCPF}$$

where UOL≡Units per Order Lot

and HCPF≡Holding Capacity per Facing

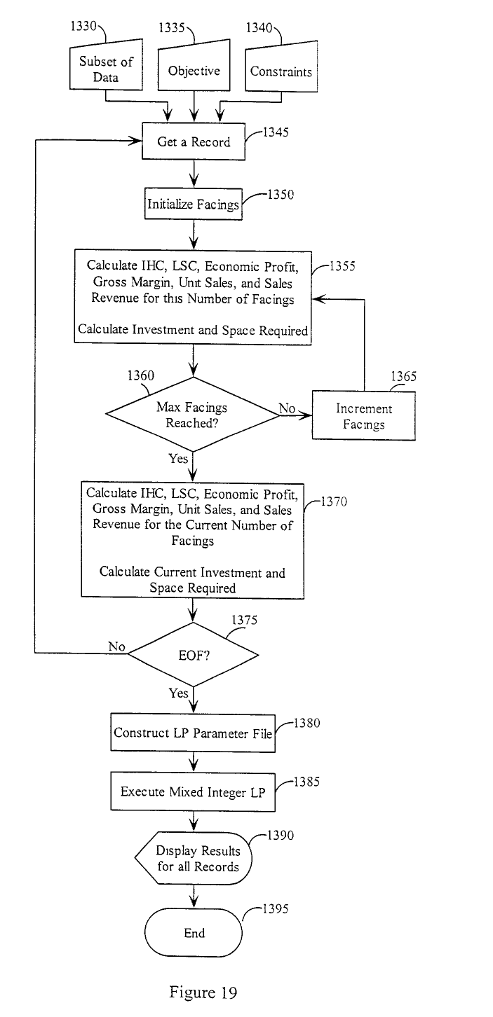

The process for merchandise optimization in the Constrained Mode of this embodiment is illustrated in the flow diagram in FIG. 19. The constrained optimization process begins with the input of a user-selected subset of data 1330, a user selected objective function 1335, and user selected constraints and constraint parameters 1340. Then the process enters a loop to generate the coefficients for the integer linear program for each record in the data set. The loop begins by retrieving a record of data at step 1345. Next, the number of facings is initialized to zero at step 1350. Zero is used so that the optimization may choose to delete an item by giving it zero facings. The next step is to calculate Inventory Holding Cost (IHC), Lost Sales Cost (LSC), Economic Profit, Gross Margin, Unit Sales, Sales Revenue, and the inventory investment and space required for the given number of facings at step 1355. These calculations provide the coefficients for the objective function and the investment and space constraints. The coefficients must be calculated for every possible number of facings for the item up to the user entered maximum number of facings 1385 (or maximum number of order lots 1310 converted to facings), so the process next tests if the maximum number of facings has been reached at step 1360. If the maximum number of facings has not been reached, the process enters a second loop where it increments the number of facings at step 1365, calculates the coefficients for the new number of facings at step 1355, and again tests if the maximum number of facings has been reached at step 1360. When the maximum number of facings is reached, the process exits this second loop and calculates the IHC, LSC, Economic Profit, Gross Margin, Unit Sales, Sales Revenue, and the inventory investment and space required for the user entered current number of facings (or current number of order lots converted to facings) at step 1370, to allow for comparison of the current and optimal solutions. At this point, the processing of one record is complete. The process checks for the end of the file (EOF) at step 1375. If there are still records in the file, the next record is retrieved at step 1345 and the process repeats. All records in the data set are processed through this loop until the end of the file is reached.

When all records have been processed, the end of file test at step 1375 gives a positive result. The next step is to use the data imported by the user, user entered parameters, and coefficients calculated previously in the process to construct the parameter file for the linear program at step 1380. Once the parameter file has been constructed, the mixed integer linear program is executed at step 1385 using any of a number of modeling and optimization software packages. The present invention uses a DASH product specifically XPRESSMP, which is produced by Dash Associates Ltd., also known as Dash Optimization, a company at 560 Sylvan Avenue, Englewood Cliffs, N.J., or a CPLEX product specifically CPLEX Optimizer, which is produced by ILog Corporation, a company with an office at 1080 Linda Vista Avenue, Mountain View, Calif., to solve the mixed integer linear program. After the linear program is executed at step 1385, the solution results are displayed for all records at step 1390, and the process reaches a normal conclusion at step 1395.

The key data and the calculations for the coefficients generated in the constrained optimization process are the same as those disclosed for the previous embodiments, with the addition of the calculation for inventory investment. The following equation uses previously defined terms and the calculation is performed for a specific number of facings of a particular item.

Investment≡Average Financial Inventory Investment required for the given number of facings

Investment≡AIL·C

The formulation of the model for constrained optimization in the present embodiment is as discussed previously with one exception. The constraint formulated for linear shelf space is not used in all instances of the model. Instead, all instances of the model use either the space constraint or the inventory investment constraint. These constraints may also be used concurrently.

When the optimization is complete, the user may employ a variety of metrics to evaluate the solution. In addition to the metrics disclosed for the previous embodiments, additional metrics are calculated for both constrained and unconstrained optimizations to provide helpful information for users interested in inventory investment and warehousing space. The following metrics are calculated for each item in the analysis and are annual figures:

Optimal Order Lots (OOL), conversion of the facing output from the optimization into order lots:

$$\frac{OptimalFacings \cdot HCPF}{UOL}$$

Average Inventory Investment Dollars, calculated for both current and optimal solutions:

AIL·C

Cube, calculated for the optimal solution: OOL·OLH·OLW·OLD

where OLH≡height of an order lot

OLW≡width of an order lot

and OLD≡depth of an order lot

As with the previous embodiments, the user of this exemplary embodiment has many options after viewing the results of an optimization run. The user may test different parameters, constraints, data, or objective functions by creating new scenarios. The user may initiate a collaboration internal or external to the company. And ultimately, when a satisfactory solution has been reached, the product assortment, facings, and order lots from the solution are used by the on-line retailer or hybrid retailer to set product assortment, inform replenishment processes, and determine warehouse space usage for daily operation.

While the most immediate use of the present invention is collaborative optimization of product assortment, facings, and order lots for the basic on-line retail operation, there are additional applications of the process that enable further optimization of inventory and investment. There are several embodiments of the present invention that can aid the on-line retailer in working with third-party drop shipments. The invention may be used to analyze which items to drop ship, identify the optimal inventory for the supplier to maintain, and enable collaboration between the on-line retailer and the third party.

To use the present invention to analyze the potential to drop ship items, the user must first create a base scenario containing the items he wishes to carry. Then an additional scenario is created for each item or combination of items that is to be tested for drop shipment. In each additional scenario, one item or group of items is removed from the data set and then the optimization is run. By comparing the results of the additional scenarios with the base scenario, the economic impact of drop shipment of those items can be deduced. Those items with a smaller impact are more economically viable for drop shipment.

The supplier handling the drop shipments can use the present invention to determine the optimal number of order lots of product to hold for the drop shipments. The supplier simply runs the optimization, as disclosed in this document, for the drop ship items using data, like lead time and variability in lead time, that is appropriate to the supplier. Finally, both of these embodiments can be performed in the collaborative environment enabled by the present invention, allowing the on-line retailer and third party supplier to operate more closely.

The described exemplary embodiment offers many advantages to on-line retailers and their suppliers. It provides merchandise optimization to determine optimal assortment and order lots for an on-line retail site. It can be used in the unconstrained mode to determine benchmarks and in the constrained mode to determine the best use of available inventory investment. It takes into account the tradeoffs between the cost of holding inventory and the cost of a stockout. It optimizes over a variety of objectives and constraints, allowing the user to tailor the invention to his business objectives, including maximizing profit or gross margin, and limitations, including limitations on inventory investment. And it enables true collaboration between multiple parties involved in and impacted by product assortment and target stock level decisions.

### ECONOMIC BIDDING PROCESS

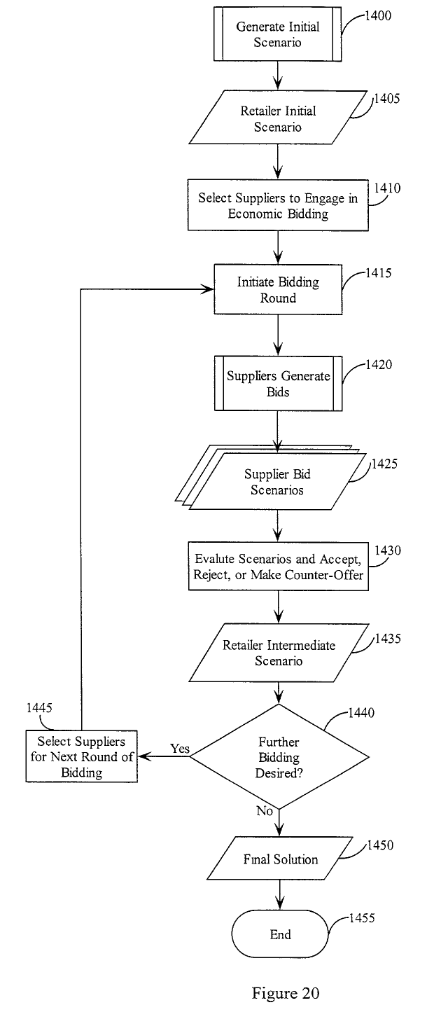

In two additional exemplary embodiments, the present invention enables an economic bidding process. Using the merchandise optimization and collaboration methods in the embodiments disclosed above, a bidding process has been created which enables retailers to generate competition between suppliers for merchandising space or inventory investment for items in branded, replenished categories. As used herein, the term “branded, replenished category” is defined as a category containing branded, replenished items. The items in such a category may be branded or private label. The present invention is practiced with both types of goods. In the bidding process disclosed herein, the use of the same set of data, financial metrics, and economic model by all parties facilitates comparison of bids based on a wide variety of variables, as opposed to comparison based on cost alone as in traditional bidding. Suppliers can propose bids, and retailers evaluate them, based on an economic picture that is larger than cost alone. Hence, the bidding process enabled by the present invention is termed an “economic” bidding process. There are many potential variations of the economic bidding process disclosed herein. The discussion below, in conjunction with FIGS. 20, 21, and 22, presents two main forms of the process, parallel and sequential bidding. Regardless of the form of the process, economic bidding will involve a retailer and any number of suppliers of products in branded, replenished categories.

The process for the parallel bidding embodiment of economic bidding process is illustrated in the flow diagram in FIG. 20. The term “parallel” is used because, in each round of bidding, the suppliers create their bids independently and potentially simultaneously. The actions indicated in FIG. 20 are performed by the retailer unless otherwise noted. To begin the parallel bidding process, the retailer generates an initial scenario at step 1400. The retailer creates a scenario, using the embodiments disclosed above, representing the product assortment and facings or order quantities for the group of products he wishes to involve in the bidding process. The group of products may be as small as a sub-category or as large as an entire store. The scenario may represent current practice by the retailer. Alternatively, the scenario may be optimized using one of the merchandise optimization methods (space optimization or investment optimization) disclosed previously. This step produces the Retailer Initial Scenario 1405. Next, the retailer must select the suppliers to engage in the bidding process at step 1410. The retailer may want to include in the bidding all or only a portion of the suppliers of the products in the Initial Scenario 1405. The retailer may also want to include suppliers whose products are not in the Initial Scenario 1405. Once the suppliers are selected, the retailer initiates the bidding and submits the appropriate data from the Retailer Initial Scenario 1405 to each party at step 1415. This step involves inviting the suppliers into a collaboration and permissioning the data.

The parallel economic bidding process continues with the suppliers generating their bids at step 1420. Through this sub-process, which will be discussed in detail below, each supplier adjusts parameters for the merchandise optimization to achieve a scenario that they believe will satisfy their objectives and those of the retailer. This is considered a bid because, unless a supplier is satisfied with the retailer's scenario, the supplier must make some type of concession or change in order to achieve satisfactory results. This is considered an economic bid because the supplier may change parameters other than the price of the product to the retailer, such as width of packaging, case pack quantities, optimization objective, or any other relevant parameter or constraint disclosed in this document. This sub-process at step 1420 produces several Supplier Bid Scenarios 1425 (one from each supplier submitting a bid) which contain the product assortments and number of facings or order quantities that the suppliers wish to propose to the retailer.

When the retailer receives the Supplier Bid Scenarios 1425, he must evaluate and compare the scenarios at step 1430 to determine which bids will best meet his objectives. Since all the suppliers and the retailer are using the same data and optimization methods, it is possible to truly compare the bids. It is possible for the retailer to see the impact of changes to parameters beyond cost, so one supplier's change in price can be compared to another's change in case pack quantity, for example. Based on the determination, the retailer accepts, rejects, or makes counter-offers to the suppliers' bids by creating a new scenario that incorporates the appropriate bid elements and counter-offers at step 1430. A ‘bid element’ is a portion of a bid. The portion may be as small as one product and its parameters or as large as an entire bid scenario. The retailer's evaluation and subsequent action taken produce a Retailer Intermediate Scenario 1435 which contains the supplier bid elements desired by the retailer and other counter-offers.

At the next bidding process step, the retailer must decide whether further bidding is desirable at step 1440. The retailer must choose whether or not to continue the bidding process. If the retailer desires further supplier input, then bidding should continue. If the intermediate scenario 1435 contains counter-offers, it is necessary to continue the bidding process in order to get the suppliers' responses to the counter-offers. If further bidding is desired, the retailer must select the suppliers for the next round of bidding at step 1445. The retailer may wish to send the intermediate scenario 1435 to all of the suppliers involved in the bidding up to this point or a subset of suppliers. In contrast, the retailer may wish to include new suppliers in the bidding process. Then the retailer initiates the next round of bidding at step 1415, the suppliers generate bids at step 1420 producing Supplier Bid Scenarios 1425, the retailer evaluates the scenarios and takes appropriate action at step 1430 producing a Retailer Intermediate Scenario 1435 and again decides if further bidding is desired at step 1440. This loop continues until the retailer determines at step 1440 that no further bidding is desirable. When the retailer decides that the bidding is complete, then the intermediate scenario 1435 becomes the final solution 1450 that will be used for setting the shelf or determining inventory investment allocation and the economic bidding process is complete at step 1455.

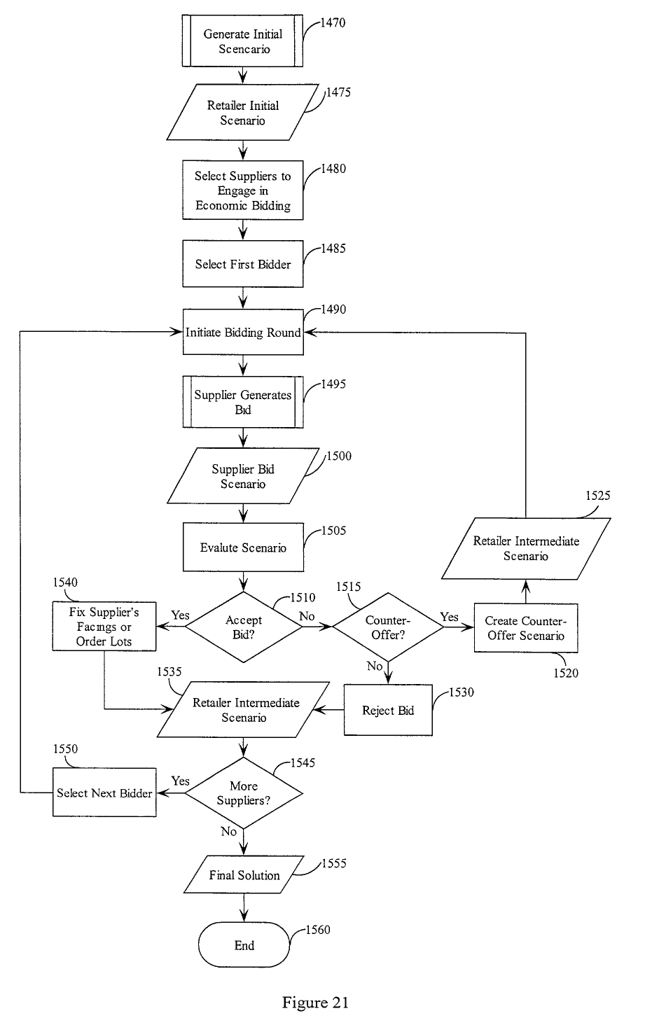

The process for the sequential bidding embodiment of economic bidding process is illustrated in the flow diagram in FIG. 21. The term “sequential” is used because each round of bidding involves a single supplier with whom an agreement is reached before the next supplier is approached. The actions indicated in FIG. 21 are performed by the retailer unless otherwise noted. To begin the sequential bidding process, the retailer generates an initial scenario at step 1470. Using the embodiments disclosed herein, the retailer creates a scenario representing the product assortment and facings or order quantities for the group of products for which he wishes to obtain bids. The group of products may be as small as a sub-category or as large as an entire store. A retailer may create a scenario representing current practice, or he may create an optimized scenario by using one of the merchandise optimization methods disclosed above. This step produces the Retailer Initial Scenario 1475. Next, the retailer must select the suppliers to engage in the bidding process at step 1480. The retailer may want to include in the bidding all or only a portion of the suppliers of the products in the Initial Scenario 1475. The retailer may also want to include suppliers whose products are not in the Initial Scenario 1475. In sequential bidding, the retailer will deal with each supplier individually, completely finishing the bidding process with one before moving on to the next. So once the suppliers are selected, the retailer must choose at step 1485 which he wishes to bid first. Upon selecting the first bidder at step 1485, the retailer initiates the bidding and submits the appropriate data from the Retailer Initial Scenario 1475 to the supplier at step 1490. In the current embodiments of our merchandise optimization method and computer program, this step involves inviting the supplier into a collaboration and permissioning the data.

The sequential economic bidding process continues with the supplier generating his bid at step 1495. Through this sub-process, which will be discussed in detail below, the supplier adjusts parameters for the merchandise optimization to achieve a scenario that he believes will satisfy his objectives as well as those of the retailer. This is considered a bid because, unless the supplier is satisfied with the retailer's scenario, the supplier must make some type of concession or change in order to achieve satisfactory results. This is considered an economic bid because the supplier may change parameters other than the price of the product to the retailer, such as width of packaging, case pack quantities, optimization objective, or any other relevant parameter or constraint disclosed in this document. This sub-process at step 1495 produces a Supplier Bid Scenario 1500 that contains the product assortments and number of facings or order quantities that the supplier wishes to propose to the retailer. When the retailer receives the Supplier Bid Scenario 1500, he must evaluate the scenario at step 1505 to determine if the bid or a portion of it will help him meet his objectives. This is one of the key innovations of this process. Since the supplier and the retailer are using the same data and optimization methods, it is possible to truly compare the bid with the initial proposal and other bids. It is possible for the retailer to see the impact of changes to parameters beyond cost, so the impact of a supplier's change in case pack quantity can be seen, for example, in the facings and metrics for other products.

Based on the evaluation at step 1505, the retailer must make several decisions about how to respond to the bid. The first decision is whether to accept the bid 1500 in its entirety at step 1510. If the retailer wants to make all changes purposed by the supplier, he should accept the bid. If the retailer wants to reject some or all of the elements of the bid, he should not accept the bid. If the retailer does not wish to accept the bid 1500 in its entirety at step 1510, he must decide if he wishes to make a counter-offer at step 1515. If the retailer wants to accept a portion of the bid or propose an alternative scenario, a counter-offer should be made. In order to propose a counter-offer, the retailer must create a counter-offer scenario at step 1520 by adjusting parameters to incorporate the desired supplier bid elements and any other counter-offers. The resulting scenario is a Retailer Intermediate Scenario 1525. At this point, the retailer initiates another round of bidding with the supplier at step 1490 and the process continues as above until the retailer must again decide whether to accept the bid 1500 in step 1510. If the retailer does not feel any of the elements of the supplier's bid 1500 or an alternative proposal would be beneficial, a counter-offer will not be made at step 1515. Then the retailer rejects the supplier's bid 1500 at step 1530. This step may include notification of the supplier. Depending on the reaction of the supplier, it is possible that the retailer may decide to change his decision regarding making a counter-offer at step 1515 and in fact make a counter-offer as above. The rejection of the bid at step 1530 produces a Retailer Intermediate Scenario 1535 containing none of the proposed bid elements. In this case, the Retailer Intermediate Scenario 1535 is the same as that sent to the supplier at the beginning of the round of bidding. If the retailer decides to accept the bid 1500 in its entirety at step 1510, then the retailer fixes the facings or order lots at step 1540 to the number agreed upon and requires the products to be kept as part of all subsequent scenarios so that the facings or order lots cannot change during optimization in further rounds of bidding. This is done using the ‘Assortment Override’ and ‘Fix Facings’ or ‘Fix Order Lots’ item-level constraints disclosed above. This produces a Retailer Intermediate Scenario 1535 with product assortment and facings or order quantities reflecting the acceptance of the bid.

As the next bidding process step, the retailer must determine whether there are more suppliers to involve in the bidding at step 1545. If there are more suppliers from the initially selected group of bidders that the retailer wishes to participate, or if the retailer has new suppliers to include, then the bidding should continue. To continue the bidding process, the retailer must select the supplier that will be the next participant at step 1550. Then the retailer initiates the next round of bidding at step 1490 and the process continues as above until the retailer must again determine whether there are further suppliers to be included in the bidding process at step 1545. This loop continues until the retailer determines at step 1545 that there is no need for inclusion of further suppliers. At this point the bidding is complete and the intermediate scenario 1535 becomes the final solution 1555 that will be used for setting the shelf or determining inventory investment allocation and the economic bidding process is complete at step 1560.

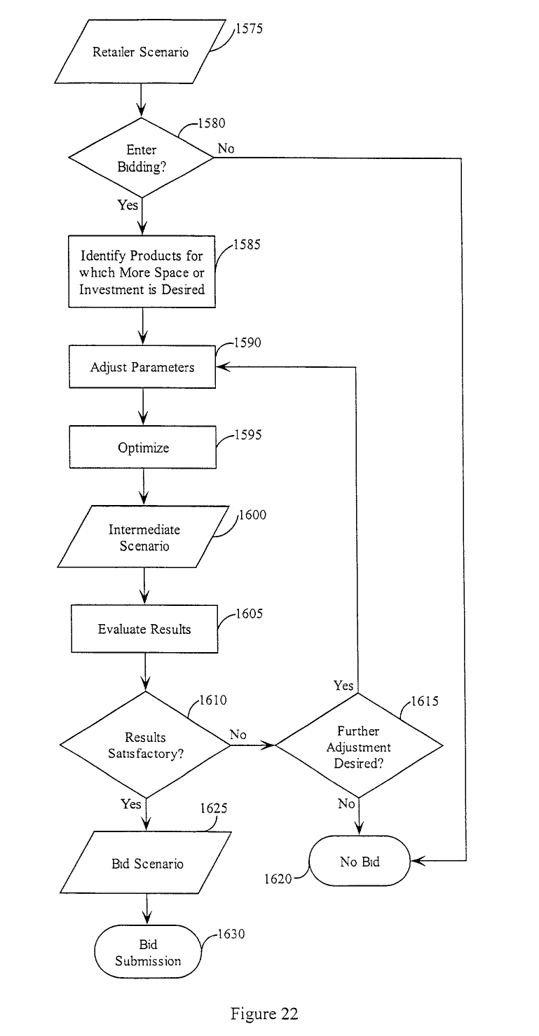

As part of both the parallel and sequential economic bidding processes, suppliers generate bids. The supplier bid generation sub-process is illustrated in the flow diagram in FIG. 22. A Retailer Scenario 1575 is the input to the supplier bid generation process. This scenario may be a Retailer Initial Scenario 1405, 1475 or a Retailer Intermediate Scenario 1435, 1525, 1535. As the first step in the bid generation process, the supplier must decide whether or not to participate in the bidding round at step 1580. If the supplier does not wish to participate in the round of bidding, then the supplier will not submit a bid and the process is terminated at step 1620. Otherwise, the supplier continues the process by identifying products for which more merchandising space or inventory investment is desired at step 1585. The supplier evaluates the Retailer Scenario 1575 to determine the status of products and how this impacts his objectives. Through this evaluation the supplier decides which products are allocated less space or investment than he desires for them. These products will be the target of his bidding and optimization efforts.

Next, the supplier begins to create his bid by adjusting parameters at step 1590 in the Retailer Scenario 1575. This step is how the supplier proposes his bid elements. The supplier can adjust a variety of parameters in the merchandise optimization application, including price, dimensions of the product, case pack quantities, marketing development funds, and the optimization objective. The supplier makes adjustments based on what he thinks will help him acquire the space or investment he desires. Generally speaking, bidding is done through price alone. The bidding process disclosed herein, however, is called economic bidding because the supplier can bid for the space using incentives other than price. All disclosed parameters or constraints over which a supplier has control or influence can be considered in the creation of the bid. Of special significance is the ability to include marketing development funds in the bid. Large market players may be wary of, and may even face legal barriers to, decreasing the price of their product to the retailer. Instead, they may offer a lump sum up front, termed marketing development funds. Traditionally, it is hard to evaluate the impact of these funds when comparing them to price reductions from other suppliers. This economic bidding process, however, can incorporate the funds and show their impact, enabling both the supplier and retailer to make better-informed decisions. The inclusion of marketing development funds is discussed further below.

As the next step in the supplier bid generation process, the supplier uses the merchandise optimization methods disclosed above to optimize at step 1595 the scenario containing the parameter changes, in order to determine the impact of those changes. This optimization at step 1595 creates an Intermediate Scenario 1600. The supplier must next evaluate the results at step 1605. The supplier evaluates the optimized scenario 1600 to see if the parameter changes had the desired effect. Some or all of the desired space or investment may have been gained. Alternatively, the parameter changes may have had none of the desired impact and other of the supplier's products may have been unintentionally impacted either positively or negatively. Based on the evaluation, the supplier must determine if the results are satisfactory at step 1610. If the supplier achieved his goals and is comfortable with the parameter changes, then the results are satisfactory. Additionally, the results may be satisfactory if only a portion of the objectives where achieved. However, undesirable side effects may make the results unacceptable. If the results do not meet with the supplier's approval, he must decide if he wishes to continue attempting to gain the space or investment for his products by making further parameter adjustments at step 1615. There may be additional adjustments he is willing to make or there may be nothing further he wishes to do. If further adjustment is desired at step 1615, then the supplier adjust parameters in the Intermediate Scenario 1600 at step 1590, optimizes at step 1595 to produce a new Intermediate Scenario 1600, evaluates the results at step 1605, and determines whether the results are satisfactory at step 1610. This loop continues until either of two situations occurs. First, if the supplier is not satisfied with the results of the parameter adjustments at step 1610, but does not feel any other adjustments would be feasible or beneficial at step 1615, then the supplier does not submit a bid to the retailer and the process is terminated at step 1620. Second, if the supplier is satisfied with the results of the parameter adjustments at step 1610, the Intermediate Scenario 1600 becomes the Bid Scenario 1625 representing the suppliers proposed product assortment and facings or order quantities. The Bid Scenario 1625 is then submitted to the retailer and the bid generation process reaches a normal conclusion at step 1630.

As discussed in the preceding paragraphs on supplier bid generation, marketing development funds (MDF) may be incorporated into the merchandise optimization process and thus considered in the economic bidding process. The inclusion of MDF requires a few enhancements to the merchandise optimization embodiments previously disclosed. The graphical user interface used in scenario creation (samples shown in FIGS. 9 and 18) are enhanced to allow for the entry by the user of MDF dollar amounts, identification of the SKUs with which the MDF are associated, and optional specification of a number of facings required for the payment of MDF. A particular MDF may be associated with a single SKU or multiple SKUs. Also, a user may enter one or many MDF amounts with associated SKUs and facing criteria.

Additionally, the MDF must be added to the calculation of the optimization objective function. Many objective functions have been disclosed herein. They may be generally represented as

$$min {\sum }_{i = 1}^{N} {\sum }_{j = 0}^{M} - {r}_{ij} \cdot {x}_{ij}$$

where (as defined previously)

i≡index for the SKUs (or items)

N≡the total number of SKUs being optimized

j≡index for the number of SKU facings

M≡the maximum number of facings

xᵢⱼ≡the binary variable indicating the selection of j facings of SKU i and the new general parameter

rᵢⱼ≡the calculated objective coefficient for j facings of SKU i; namely, using definitions from the Constrained Mode section above, (−TCᵢⱼ) for the objective function Minimize Total Cost, EPᵢⱼ for Maximize Economic Profit, GMᵢ·USᵢⱼ for Maximize Gross Margin, Pᵢ·USᵢⱼ for Maximize Sales Revenue, and USᵢⱼ for Maximize Unit Sales.

For inclusion of MDF in the objective function, the following term is added to the general objective function above in accordance with the SKU association and facing requirements specified by the user:

$$- ( {\sum }_{j = 1}^{M} {x}_{ij} ) Mdf$$

where

Mdf≡the marketing development funds the user is putting against a SKU or group of SKUs to keep them in the assortment.

The option to include marketing development funds in their bids is a powerful tool for suppliers. And the inclusion of MDF in the model formulation enables retailers to quantitatively evaluate the effects of such funds in view of the overall assortment and other bidding factors.

The economic bidding method described herein uses the merchandise optimization and collaboration methods of the disclosed embodiments to bring the forces of competition to the interaction between retailers and suppliers of goods in branded, replenished categories. Economic bidding provides an objective process by which retailers can acquire, evaluate, and compare economic bids from multiple suppliers with the speed and timing critical in the retail industry. Importantly, economic bidding involves many factors in addition to cost to the retailer, allowing for a wide range of bidding options for the suppliers and retailers alike.

Whereas, the present invention has been described in relation to the drawings attached hereto, it should be understood that other and further modifications, apart from those shown or suggested herein, may be made within the spirit and scope of this invention.

What is claimed is:

1. A method for facilitating economic bidding between a retailer and at least one supplier of goods in branded, replenished categories, said method comprising:
selecting at least two participants for said economic bidding, wherein one of said participants is a retailer and the other of said participants are suppliers;
generating one or more economic bid scenarios;
exchanging said economic bid scenarios between said participants;
evaluating said economic bid scenarios;
responding to said economic bid scenarios; and
deriving a final solution from said economic bid scenarios through repetition of said steps by said participants.

2. The method recited in claim 1, wherein said step of deriving is performed substantially simultaneously by said suppliers.

3. The method recited in claim 1, wherein said step of deriving is performed substantially sequentially by said suppliers.

4. The method recited in claim 1, wherein generating one or more economic bid scenarios further comprises performing merchandise optimization.

5. The method recited in claim 4 wherein said optimization enables a user to select products for either an investment or a space, said optimization further comprising:
determining at least one optimization analysis objective;
communicating operationally dependent information about various products and importing said operationally dependent information to an inventory database;
identifying a subset of data elements within said database upon which to perform an optimization analysis and communicating said subset of data elements to an optimizing computer;
performing an optimization analysis upon said subset of data elements using said computer to thereby obtain an unconstrained report and/or a constrained report; and,
providing said reports to the user to enable the user to select products for either the investment or the space.

6. The method as recited in claim 5 wherein said method further comprises facilitating collaborative multiple user access, viewing and contingent control of said execution via a communications network.

7. The method as recited in claim 6 wherein said at least one optimization analysis objective is chosen from the group including maximize unit sales, maximize sales revenue, maximize economic profit, maximize gross margin and minimize total cost.

8. The method as recited in claim 6 wherein said subset of data elements includes data to determine the cost of lost sales per unit.

9. The method as recited in claim 8 wherein said cost of lost sales is determined based upon consumer responses.

10. The method as recited in claim 9 wherein said consumer responses are chosen from the group including consumers who will go to a competitor, consumers who will never buy the product again, consumers who will never shop the store again, consumers who will make no purchases, consumers who will shop less frequently, consumers who will switch brand, consumers who will switch product, and consumers who will switch size of product, or other behavior.

11. A computer program embodied on a computer-readable medium for facilitating economic bidding between a retailer and at least one supplier of goods in branded, replenished categories, said program comprising:
a code segment to provide for selecting at least two participants for said economic bidding, wherein one of said participants is a retailer and the other of said participants are suppliers;
a code segment to provide for generating one or more economic bid scenarios;
a code segment to provide for exchanging said economic bid scenarios between said participants;
a code segment to provide for evaluating said economic bid scenarios;
a code segment to provide for responding to said economic bid scenarios; and
a code segment to provide for deriving a final solution from said economic bid scenarios through repetition of said steps by said participants.

12. The program recited in claim 11, wherein said code segment for deriving functions substantially simultaneously for said suppliers.

13. The program recited in claim 11, wherein said code segment for deriving functions substantially sequentially for said suppliers.

14. The program recited in claim 11, wherein generating one or more economic bid scenarios further comprises a code segment for performing merchandise optimization.

15. The program recited in claim 14 wherein said optimization enables determination of either optimal investment utilization or optimal space utilization and further comprises:
a code segment for determining at least one optimization analysis objective;
a code segment for communicating operationally dependent information about various products and for importing said operationally dependent information to an inventory database;
a code segment for identifying a subset of data elements within said database upon which to perform an optimization and a code segment for communicating said subset of data elements to said optimization;
a code segment for performing said optimization upon said subset of data elements to produce an unconstrained and/or a constrained optimization analysis; and,
a code segment for providing the optimization analysis to a user.

16. The program as recited in claim 15 wherein said importing of operationally dependent information to said inventory database further comprises:
a code segment to provide for selection of files for import;
a code segment to validate said file selection;
a code segment to perform import data transformations; and,
a code segment to import said transformed data to said database.

17. The program as recited in claim 15 wherein said identification of said subset of data elements further comprises:
a code segment to display data elements contained in said imported database files; and,
a code segment to enable a user to specify which of said data elements are to be filtered for subsequent display and further analysis using said optimization.

18. The program as recited in claim 15 wherein said performance of an optimization is unconstrained and further comprises:
a code segment to allow the user to update settings for the optimization and to initiate the optimization process;
a code segment to execute the optimization process; and,
a code segment to calculate relevant financial and operational metrics.

19. The program as recited in claim 15 wherein said performance of an optimization is constrained and further comprises:
a code segment to allow the user to update settings for the optimization and to initiate the optimization process;
a code segment to control the linear programming optimization process; and,
a code segment to calculate relevant financial and operational metrics.

20. The program as recited in claim 15 wherein said at least one optimization analysis objective is chosen from the group including maximize unit sales, maximize sales revenue, maximize economic profit, maximize gross margin and minimize total cost.

21. The program as recited in claim 15 wherein, said subset of data elements includes data to determine cost of lost sales per unit.

22. The program as recited in claim 21 wherein said cost of lost sales is determined based upon consumer responses.

23. The program as recited in claim 22 wherein said consumer responses are chosen from the group including consumers who will go to a competitor, consumers who will never buy the product again, consumers who will never shop the store again, consumers who will make no purchases, consumers who will shop less frequently, consumers who will switch brand, consumers who will switch product, and consumers who will switch size of product, or other behavior.
